(19) United States
(12) Patent Application Publication
(10) Pub. No.: US 2005/0181304 A1
(43) Pub. Date: Aug. 18, 2005

(54) Method of forming fine pattern

(75) Inventors: Takayuki Araki, Osaka (JP); Tsuneo Yamashita, Osaka (JP); Takuji Ishikawa, Osaka (JP); Tomohiro Yoshida, Osaka (JP); Takuya Hagiwara, Tsukuba-shi (JP); Takamitsu Furukawa, Tsukuba-shi (JP)

Correspondence Address: SUGHRUE MION, PLLC, 2100 PENNSYLVANIA AVENUE, N.W., SUITE 800, WASHINGTON, DC, 20037, US

(73) Assignees: DAIKIN INDUSTRIES, LTD; SEMICONDUCTOR LEADING EDGE TECHNOLOGIES, INC.

(21) Appl. No.: 11/057,832

(22) Filed: Feb. 15, 2005

(30) Foreign Application Priority Data
Feb. 16, 2004 (JP) 2004-38840

(51) Int. Cl. G03C 1/492

(52) U.S. Cl. 430/270.1

(57) ABSTRACT

There is provided a method of forming a fine pattern by using a highly practicable fluorine-containing polymer which has a high transparency to exposure light having a short wavelength such as F₂ laser and can improve dry etching resistance without remarkably lowering transparency. The method comprises (I) a step for preparing a resist composition comprising (a) a fluorine-containing polymer having protective group, (b) a photoacid generator and (c) a solvent; (II) a step for forming a resist film comprising the above-mentioned resist composition on a substrate or on a given layer on the substrate; (III) a step for exposing by selectively irradiating given areas of the resist film with energy ray, and (IV) a step for subjecting the exposed resist film to developing treatment and selectively removing the exposed portions of the resist film to form a fine pattern, in which the fluorine-containing polymer (a) having protective group is a fluorine-containing polymer comprising a structural unit (M2-1A) derived from a norbornene derivative having OH group and a structural unit (M2-1B) derived from a norbornene derivative having a saturated hydrocarbon group containing bicyclo saturated hydrocarbon structure as a protective group.

### BACKGROUND OF THE INVENTION

The present invention relates to a method of forming a fine pattern in production of semiconductor equipment.

Ultra fine fabrication is required for various electronic parts such as semiconductor integrated circuit, and a resist is widely used for a processing technology therefor. With the pursuit of multi functions and high density of electronic parts, ultra fine fabrication of a resist pattern to be formed is demanded. As the resist used for fabrication of such an ultra fine pattern, there are, for example, chemically amplifying resists disclosed in JP63-27829A, etc.

A chemically amplifying positive resist is, for example, a two component composition comprising a photoacid generator and a polymer (resist polymer) being soluble in alkali, in which a group (protective group) having an effect of inhibiting dissolution of the polymer is introduced to the polymer. In an un-exposed state, solubility in an alkaline developing solution is inhibited by the protective group.

When the resist film formed on a substrate is irradiated with light, X-ray, high energy electron beam or the like, a photoacid generator is decomposed at an exposed portion and an acid is generated and when the resist film is further subjected to heat-treating after the exposure, the acid acts as a catalyst to decompose the protective group in the resist polymer. Therefore an intended pattern can be formed by dissolving and removing, with a developing solution, the exposed portion, in which the protective group in the resist polymer has been decomposed.

For forming a pattern using such a resist composition, a reduction projection exposure system usually called a stepper is generally used as an exposure system. As a result of a recent remarkable progress of multi functions and high density of electronic parts, a further fine circuit is demanded, which makes it necessary to form a fine pattern.

In the above-mentioned exposure system, since a pattern fabrication is carried out by projecting an optical image on a substrate, a limit of resolution depends on a wavelength of light used for the exposing. For further fine fabrication, a wavelength of light source used for the exposing has been shortened. It is a matter of certainty that in production of a device coming after a giga bit memory era, F₂ laser having a wavelength of 157 nm will be mainly used as light source. Therefore, development of a chemically amplifying positive resist capable of forming a fine pattern using F₂ laser as light source are proceeded with.

However polymer materials which have been used for conventional resist absorbs a large amount of F₂ laser having a wavelength of 157 nm. When F₂ laser is used for the exposing of a photosensitive resist composition prepared from such polymer materials, sufficient amount of exposure light does not reach the bottom of the resist. Therefore uniform exposing in the direction of a depth of the photosensitive composition formed on the substrate cannot be carried out, and it is difficult to enhance resolution.

Among polymer materials being excellent in transparency to F₂ laser, fluorine-containing polymers are promising. For application to a resist, alkali soluble fluorine-containing polymers mentioned above which have both of transparency and dry etching resistance and have introduced protective groups (functional groups) are desired to be developed.

Recently various fluorine-containing polymers having a norbornene backbone have been studied as a resist polymer being excellent in transparency to F₂ laser. For example, in International Publication Nos. WO00/67072, WO03/006413 and WO03/007080, there are proposed fluorine-containing polymers prepared by copolymerizing norbornene derivatives having each of the functional group: 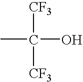
and the OH-protected functional group: 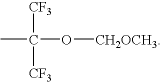
There are exemplified copolymers of tetrafluoroethylene (TFE) and the norbornene derivative having the above-mentioned functional groups.

However in the studies having been made so far, copolymers comprising TFE and norbornene derivative is excellent in transparency, but is insufficient in dry etching resistance from the viewpoint of practicability.

As a result, even if a resist pattern can be formed, a resist polymer cannot withstand dry etching treatment when forming a circuit pattern by etching a substrate or a specific layer on the substrate through the pattern and a desired circuit pattern is difficult to form.

The present situation is such that in the studies having been made so far with respect to fluorine-containing polymers for resist, even if dry etching resistance is comparatively good, transparency to F₂ laser is greatly lowered, and fluorine-containing polymers for resist being highly practicable and having both of transparency and dry etching resistance have not been obtained.

Intensive studies have been made to solve the mentioned problems and the present invention was completed based on new findings obtained therefrom. An object of the present invention is to provide a method of forming a fine pattern by using, as a resist, a highly practicable fluorine-containing polymer having high transparency to exposure light having a short wavelength such as F₂ excimer laser, in which dry etching resistance can be improved without lowering transparency remarkably.

### SUMMARY OF THE INVENTION

The present inventors have found that fluorine-containing polymers obtained by polymerizing a norbornene derivative having OH group and introducing specific protective group to the polymer have excellent transparency to exposure light having a short wavelength such as F₂ excimer laser and high dry etching resistance, and when a resist composition prepared therefrom is used, a highly practicable fine pattern can be formed for making a highly integrated circuit for semiconductor devices, etc., and thus the present invention was completed.

Namely, the present invention relates to a method of forming a fine pattern which comprises:
(I) a step for preparing a resist composition comprising:
(a) a fluorine-containing polymer having protective group,
(b) a photoacid generator and
(c) a solvent;
(II) a step for forming a resist film comprising the above-mentioned resist composition on a substrate or on a given layer on the substrate;
(III) a step for exposing by selectively irradiating given areas of the resist film with energy ray, and
(IV) a step for subjecting the exposed resist film to developing treatment and selectively removing the exposed portions of the resist film to form a fine pattern,
   in which the fluorine-containing polymer (a) having protective group is a fluorine-containing polymer comprising a structural unit (M2-1A) derived from a norbornene derivative (m2-1a) having OH group which has a moiety represented by the formula (1): 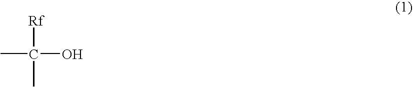
   wherein Rf is a fluorine-containing alkyl group having 1 to 5 carbon atoms, and
a structural unit (M2-1B) derived from a norbornene derivative (m2-1b) having protective group which has a moiety represented by the formula (2): 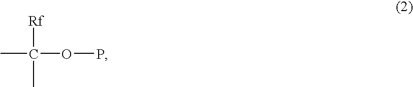
   wherein Rf is as defined in the formula (1); —O—P is a protective group which is converted to OH group due to reaction with an acid, in which —P is represented by the formula (2-1): 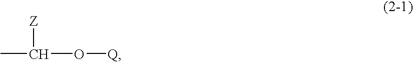
   wherein Z is hydrogen atom or CH₃; Q is a saturated hydrocarbon group having 4 to 15 carbon atoms and having a bicyclo saturated hydrocarbon structure W and the number of carbon atoms forming the ring structure W of the bicyclo saturated hydrocarbon is from 4 to 12.

Also the present invention relates to a resist composition comprising:
(a) a fluorine-containing polymer having protective group,
(b) a photoacid generator and
(c) a solvent,
   in which the fluorine-containing polymer (a) having protective group is a fluorine-containing polymer comprising the structural unit (M2-1A) derived from the norbornene derivative (m2-1a) having OH group which has the moiety represented by the mentioned formula (1) and the structural unit (M2-1B) derived from the norbornene derivative (m2-1b) having protective group which has the moiety represented by the mentioned formula (2).

In the formula (2-1) representing —P in the protective group —O—P, the followings are preferable.
(1) Z is hydrogen atom.
(2) The hydrocarbon group Q having the bicyclo saturated hydrocarbon structure W is a cyclic hydrocarbon group represented by the formula (2-2): 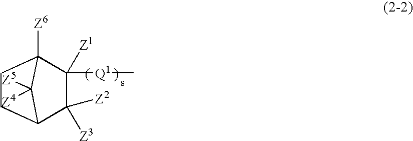
   wherein Q¹ is an alkylene group having 1 to 5 carbon atoms, in which a part or the whole of hydrogen atoms may be substituted with fluorine atoms; Z¹ is at least one selected from hydrogen atom, fluorine atom or an alkyl group having 1 to 5 carbon atoms, in which a part or the whole of hydrogen atoms may be substituted with fluorine atoms; Z² and Z³ are the same or different and each is at least one selected from hydrogen atom, fluorine atom, CH₃ and CF₃; Z⁴, Z⁵ and Z⁶ are the same or different and each is hydrogen atom or CH₃; s is 0 or 1.

Particularly preferable are as follows.
(2-1) In the formula (2-2) representing the hydrocarbon group Q having the bicyclo saturated hydrocarbon structure W, Z¹ is hydrogen atom, s is 1 and Q¹ is —CH₂—.
(2-2) In the formula (2-2) representing the hydrocarbon group Q having the bicyclo saturated hydrocarbon structure W, all of Z², Z³, Z⁴, Z⁵ and Z⁶ are hydrogen atoms.
(3) The hydrocarbon group Q having the bicyclo saturated hydrocarbon structure W is at least one cyclic hydrocarbon group selected from the group represented by the formulae (2-3-1), (2-3-2), (2-3-3) and (2-3-4): 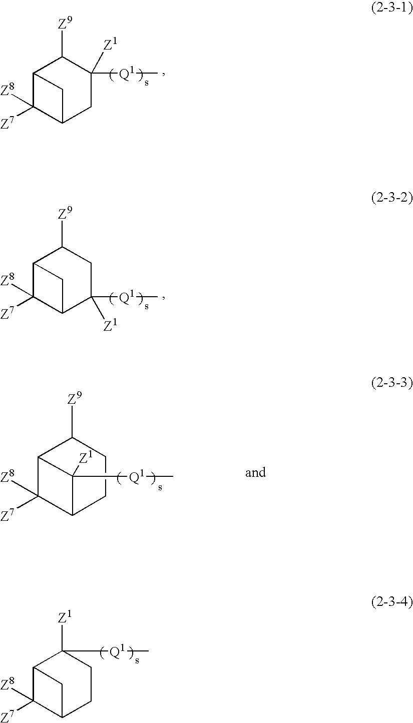
   wherein Q¹, Z¹ and s are as defined in the formula (2-2); Z⁷, Z⁸ and Z⁹ are the same or different and each is hydrogen atom or CH₃. Particularly preferred are those having the hydrocarbon group Q represented by the formula (2-3-1).

Particularly preferable are as follows.
(3-1) In the formulae (2-3-1), (2-3-2), (2-3-3) and (2-3-4) hydrocarbon group Q having the bicyclo saturated hydrocarbon structure W, all of Z⁷, Z⁸ and Z⁹ are CH₃.

Also preferred as the fluorine-containing polymer (a) having protective group is a polymer represented by the formula (M-1):
-(M1)-(M2-1A)-(M2-1B)-(N)- (M-1)
wherein the structural unit M1 is a structural unit derived from a fluorine-containing ethylenic monomer (m1) having 2 or 3 carbon atoms and at least one fluorine atom;
the structural unit M2-1A is the structural unit derived from the norbornene derivative (m2-1a) having OH group which has the moiety represented by the formula (1);
the structural unit M2-1B is the structural unit derived from the norbornene derivative (m2-1b) having protective group which has the moiety represented by the formula (2);
the structural unit N is a repeat unit derived from a monomer (n) copolymerizable with the monomers (m1), (m2-1a) and (m2-1b); the structural units M1, M2-1A, M2-1B and N are contained in amounts of from 24 to 70% by mole, from 1 to 69% by mole, from 1 to 69% by mole and from 0 to 20% by mole, respectively, and when (M1)+(M2-1A) +(M2-1B) is assumed to be 100% by mole, a percent by mole ratio of (M1)/((M2-1A)+(M2-3B)) is 30/70 to 70/30.

Preferred as the fluorine-containing polymer of the formula (M-1) are those, in which the structural unit M2-1A derived from a norbornene derivative having OH group is a structural unit derived from a norbornene derivative represented by the formula (m2-2a): 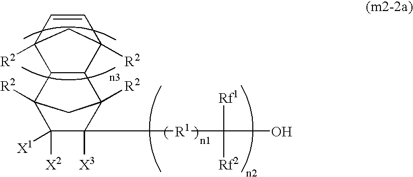
wherein X³ is selected from hydrogen atom, fluorine atom or CF₃, and when n2 is 0, X³ is CF₃; X¹ and X² are the same or different and each is hydrogen atom or fluorine atom; R¹ is at least one divalent hydrocarbon group selected from divalent hydrocarbon groups which have 1 to 5 carbon atoms and may have ether bond and divalent hydrocarbon groups which have 1 to 5 carbon atoms and may have ether bond, in which a part or the whole of hydrogen atoms are substituted with fluorine atoms; Rf¹ and Rf² are the same or different and each is a fluorine-containing alkyl group having 1 to 5 carbon atoms; R² are the same or different and each is hydrogen atom or an alkyl group having 1 to 10 carbon atoms; n1 and n2 are the same or different and each is 0 or 1; n3 is 0 or an integer of from 1 to 5, and/or
the structural unit M2-1B derived from a norbornene derivative having protective group is a structural unit derived from a norbornene derivative represented by the formula (m2-2b): 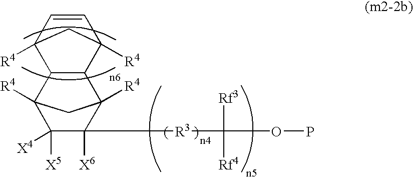
   wherein —O—P is a protective group which can be converted to OH group by dissociation reaction with an acid, and —P is represented by said formula (2-1); X⁶ is selected from hydrogen atom, fluorine atom or CF₃, and when n5 is 0, X⁶ is CF₃; X⁴ and X⁵ are the same or different and each is hydrogen atom or fluorine atom; R³ is at least one divalent hydrocarbon group selected from divalent hydrocarbon groups which have 1 to 5 carbon atoms and may have ether bond and divalent hydrocarbon groups which have 1 to 5 carbon atoms and may have ether bond, in which a part or the whole of hydrogen atoms are substituted with fluorine atoms; Rf³ and Rf⁴ are the same or different and each is a fluorine-containing alkyl group having 1 to 5 carbon atoms; R⁴ are the same or different and each is hydrogen atom or an alkyl group having 1 to 10 carbon atoms; n4 and n5 are the same or different and each is 0 or 1; n6 is 0 or an integer of from 1 to 5, and/or
the structural unit (M1) derived from the fluorine-containing ethylenic monomer (m1) is a structural unit derived from tetrafluoroethylene or chlorotrifluoroethylene.

Also it is preferable to use F₂ excimer laser as the above-mentioned energy ray.

### BRIEF EXPLANATION OF THE DRAWING

FIG. 1 is a cross-sectional view showing the method of forming a fine pattern of the present invention according to the steps thereof.

### DETAILED DESCRIPTION

The present inventors could find that dry etching resistance can be improved while maintaining transparency to light of 157 nm when specific protective group having a specific saturated hydrocarbon group of ring structure is introduced to OH group of a fluorine-containing polymer obtained by polymerizing a norbornene derivative having OH group.

Namely, the present invention relates to the method of forming a fine pattern which comprises:
(I) a step for preparing a resist composition comprising:
(a) a fluorine-containing polymer having protective group,
(b) a photoacid generator and
(c) a solvent;
(II) a step for forming a resist film comprising the above-mentioned resist composition on a substrate or on a given layer on the substrate;
(III) a step for exposing by selectively irradiating given areas of the resist film with energy ray, and
(IV) a step for subjecting the exposed resist film to developing treatment and selectively removing the exposed portions of the resist film to form a fine pattern,
   in which the fluorine-containing polymer (a) having protective group is a fluorine-containing polymer comprising the structural unit (M2-1A) derived from the norbornene derivative (m2-1a) having OH group which has the moiety represented by the formula (1): 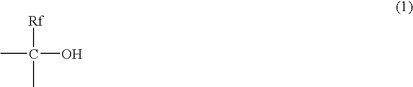
   wherein Rf is a fluorine-containing alkyl group having 1 to 5 carbon atoms, and
   the structural unit (M2-1B) derived from the norbornene derivative (m2-1b) having protective group which has the moiety represented by the formula (2): 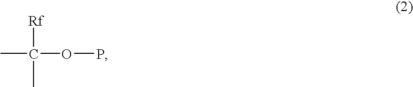
   wherein Rf is as defined in the formula (1); —O—P is a protective group which is converted to OH group due to reaction with an acid, in which —P is represented by the formula (2-1): 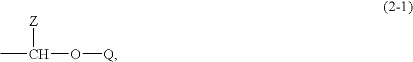
   wherein Z is hydrogen atom or CH₃; Q is a saturated hydrocarbon group having 4 to 15 carbon atoms which includes a bicyclic saturated hydrocarbon structure W having a bridged structure and is characterized in that the number of carbon atoms forming the ring structure of the bicyclic saturated hydrocarbon W is from 4 to 12.

Also the present invention relates to the resist composition comprising:
(a) a fluorine-containing polymer having protective group,
(b) a photoacid generator and
(c) a solvent,
   in which the fluorine-containing polymer (a) having protective group is a fluorine-containing polymer comprising the structural unit (M2-1a) derived from the norbornene derivative (m2-1a) having OH group which has the moiety represented by the mentioned formula (1) and the structural unit (M2-1B) derived from the norbornene derivative (m2-1b) having protective group which has the moiety represented by the mentioned formula (2).

First explained below is the fluorine-containing polymer (a) having protective group which is used for the resist composition of the present invention in the method (I) for forming a fine pattern of the present invention.

The fluorine-containing polymer (a) having protective group is capable of acting as a positive resist, and contains, as essential component, the structural unit (M2-1B) derived from the norbornene derivative (m2-1b) having protective group —O—P which can be converted to an alkali soluble group, i.e. —OH group due to dissociation with an acid.

Namely, the structural unit (M2-1B) is a structural unit derived from a norbornene derivative having the moiety represented by the formula (2):

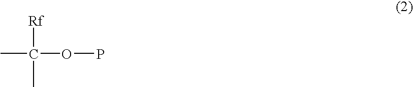

The fluoroalkyl group represented by the Rf group in the moiety of the formula (2) is one obtained by substituting a part or the whole of hydrogen atoms of an alkyl group having 1 to 5 carbon atoms with fluorine atoms. By an effect of the introduced fluorine atoms, acidity of —OH group after releasing of the protective group in the exposing step (III) can be enhanced and good solubility in a developing solution can be imparted.

Therefore the Rf group is preferably a perfluoroalkyl group since acidity of —OH group can be increased more.

Examples thereof are groups represented by:
—(CF₂)ₘCF₃,
—(CF₂)ₘ₁CF [symbol] CF₃)₂ and
—(CF₂)ₘ₂C [symbol] CF₃)₃,
   wherein m is 0 or an integer of from 1 to 4; m1 is 0, 1 or 2; m2 is 0 or 1. Concretely there are —CF₃, —C₂F₅, —CF₂CF(CF₃)₂, —CF(CF₃)₂ and the like and particularly preferred are —CF₃ and —C₂F₅, and further preferred is —CF₃.

The —P in the moiety of the formula (2) is the structure of the formula (2-1): 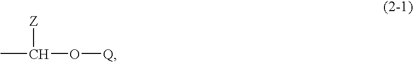
and there are concretely: 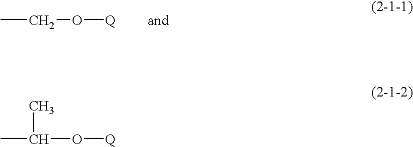
and both of (2-1-1) and (2-1-2) can be converted to —OH group due to reaction with an acid and are capable of acting for a positive resist at high sensitivity at the step for exposing.

Particularly —P represented by the formula (2-1-1):
—CH₂—O-Q (2-1-1)
is preferred since it can be converted to —OH group due to reaction with an acid at higher sensitivity and transparency of the fluorine-containing polymer is not lowered.

The hydrocarbon group Q is a monovalent saturated hydrocarbon group having 4 to 15 carbon atoms and is characterized by containing the bicyclo saturated hydrocarbon group W.

It is important that the ring structure is a bicyclo saturated hydrocarbon group. Monocyclic saturated hydrocarbon groups are not preferred since an effect of improving dry etching resistance is insufficient, and also condensed cyclic saturated hydrocarbon groups having three or more rings (adamantyl group, etc.) are not preferred since transparency is lowered.

In another aspect, it can be said that the bicyclo saturated hydrocarbon group W has a bridged structure in its ring structure. The bridged structure means such a structure that among the atoms forming the ring structure, those which are not adjacent to each other are bridged (bonded) directly or via at least one atom. Particularly preferred is a structure bridged (bonded) via at least one atom because an effect of improving dry etching resistance is highly exhibited.

The number of carbon atoms forming the ring of bicyclo saturated hydrocarbon structure is from 4 to 12, preferably from 5 to 10, more preferably from 6 to 8, particularly preferably 6 or 7.

If the number of carbon atoms forming the ring structure is too small, it is not preferred because an effect of improving dry etching resistance becomes insufficient. On the other hand, if the number of carbon atoms forming the ring structure is too large, it is not preferred because an effect of improving dry etching resistance is lowered and transparency is decreased.

A monovalent hydrocarbon group (for example, CH₃ or the like) not forming the ring structure may be bonded to any of the carbon atoms forming the ring structure.

The group Q containing the bicyclic saturated hydrocarbon group W is a hydrocarbon group having 4 to 15 carbon atoms, preferably from 5 to 12, more preferably from 6 to 10.

If the number of carbon atoms of the group Q is too small, it is not preferred because an effect of improving dry etching resistance becomes insufficient. On the other hand, if the number of carbon atoms of the group Q of the ring structure is too large, it is not preferred because an effect of improving dry etching resistance is lowered and transparency is decreased.

Examples of preferred backbone of the bicyclo saturated hydrocarbon structure W are, for instance, as follows.

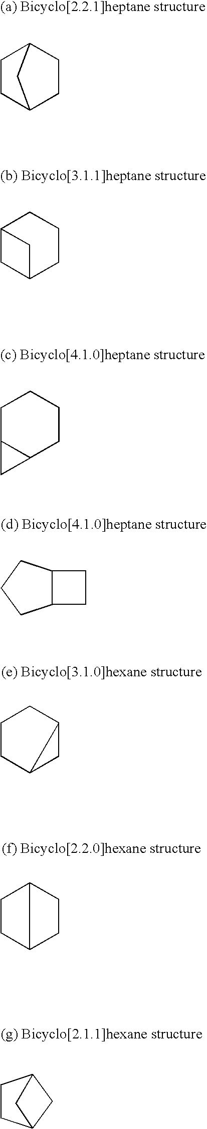

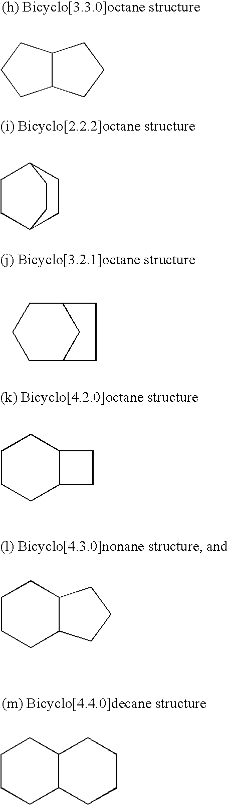

Among them, preferred ring structures are (a), (b), (e) and (m) since they are easy to obtain, transparency is difficult to be lowered and dry etching resistance is improved more. Those structures are explained below in further detail.
(a) The Hydrocarbon Group Q Having the Bicyclo[2.2.1]heptane Structure is Concretely a Cyclic Hydrocarbon Group Represented by the Formula (2-2): 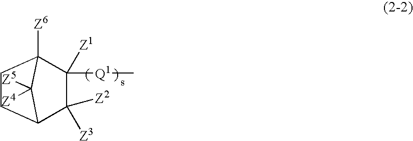
wherein Q¹ is an alkylene group having 1 to 5 carbon atoms, in which a part or the whole of hydrogen atoms may be substituted with fluorine atoms; Z¹ is at least one selected from hydrogen atom, fluorine atom or an alkyl group having 1 to 5 carbon atoms, in which a part or the whole of hydrogen atoms may be substituted with fluorine atoms; Z² and Z³ are the same or different and each is at least one selected from hydrogen atom, fluorine atom, CH₃ and CF₃; Z⁴, Z⁵ and Z⁶ are the same or different and each is hydrogen atom or CH₃; s is 0 or 1.

In the formula (2-2), as mentioned supra, Q¹ may be contained (s=1) or may not be contained (s=0). In the case of s=1, Q¹ is an alkylene group having 1 to 5 carbon atoms, in which a part or the whole of hydrogen atoms may be substituted with fluorine atoms. Examples thereof are concretely —CH₂—, —C₂H₄—, 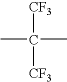
and the like, and preferred is —CH₂—.

Z¹ is at least one selected from hydrogen atom, fluorine atom or an alkyl group having 1 to 5 carbon atoms, in which a part or the whole of hydrogen atoms may be substituted with fluorine atoms. Examples thereof are concretely hydrogen atom, CH₃, fluorine atom and CF₃, and preferred is hydrogen atom.

Z² and Z³ are the same or different and each is at least one selected from hydrogen atom, fluorine atom, CH₃ and CF₃. Z⁴, Z⁵ and Z⁶ are the same or different and each is hydrogen atom or CH₃. It is particularly preferable, from the viewpoint of excellent transparency, that all of Z², Z³, Z⁴, Z⁵ and Z⁶ are hydrogen atoms, or both of Z² and Z³ are hydrogen atoms and all of Z⁴, Z⁵ and Z⁶ are CH₃, or all of Z², Z³ and Z⁶ are CH₃ and both of Z⁴ and Z⁵ are hydrogen atoms.

Examples of the hydrocarbon group of the formula (2-2) are: 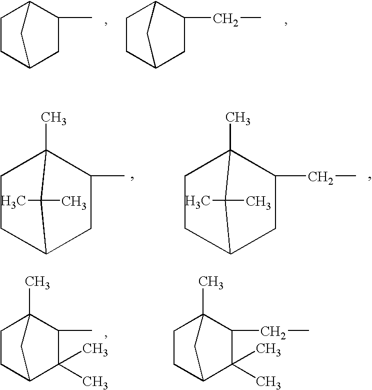
and the like.
(b) The Hydrocarbon Group Q Having the Bicyclo[3.1.1]heptane Structure is Preferably one Selected from the Formulae (2-3-1), (2-3-2), (2-3-3) and (2-3-4): 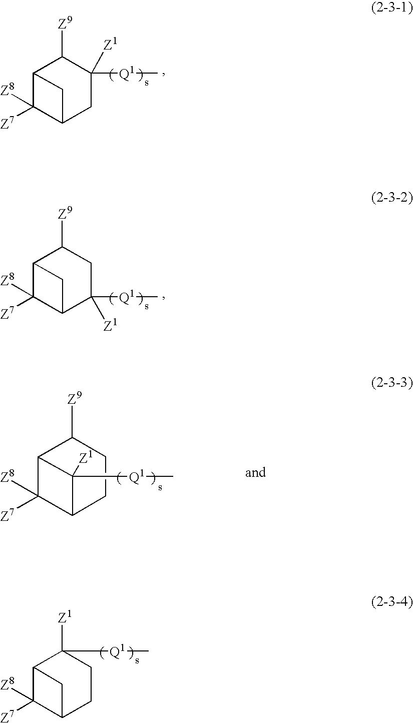
wherein Q¹, Z¹ and s are as defined in the formula (2-2); Z⁷, Z⁸ and Z⁹ are the same or different and each is hydrogen atom or CH₃, since transparency and dry etching resistance are excellent.

Preferred examples of Q¹ and Z¹ in the formulae (2-3-1), (2-3-2), (2-3-3) and (2-3-4) are the same as those in the above-mentioned formula (2-2).

In the formulae (2-3-1), (2-3-2), (2-3-3) and (2-3-4), it is preferable that all of Z⁷, Z⁸ and Z⁹ are hydrogen atom or CH₃, since they are easy to obtain and dry etching resistance is excellent.

Preferred examples of the hydrocarbon group of the formulae (2-3-1), (2-3-2), (2-3-3) and (2-3-4) are: 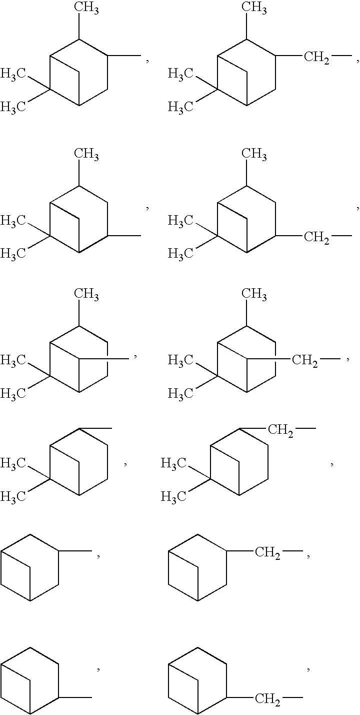
and the like.

Other examples of the hydrocarbon group Q having the bicyclic saturated hydrocarbon structure W which are preferred from the viewpoint of excellent transparency are:

(e) Hydrocarbon Groups Having the Bicyclo[3.1.0]hexane Structure

Examples thereof are: 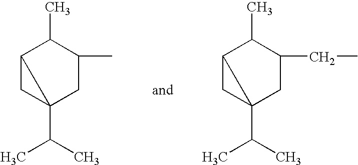
(m) Hydrocarbon Groups Having the Bicyclo[4.4.0]decane Structure

Examples thereof are:

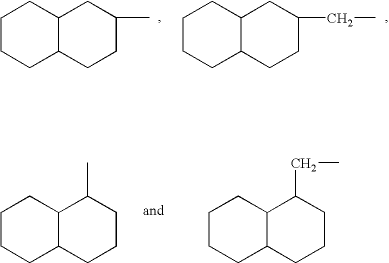

Among them, further preferred are those selected from the hydrocarbon groups Q having the bicyclo[2.2.1]heptane structure (a) or the bicyclo[3.1.1]heptane structure (b) since both of transparency and dry etching resistance are particularly excellent.

The fluorine-containing polymer (a) having protective group which is used for the resist composition in the method of forming a fine pattern of the present invention comprises the structural unit (M2-1A) derived from the OH group-containing norbornene derivative (m2-1a) having the moiety of the mentioned formula (1) and the structural unit (M2-1B) derived from the norbornene derivative (m2-1b) having the moiety of the mentioned formula (2), in which the OH group is protected by the mentioned protective group.

Therefore the fluorine-containing polymer (a) may be a copolymer comprising the structural unit (M2-1a) derived from the OH group-containing norbornene derivative and the structural unit (M2- 1B) derived from the norbornene derivative having protective group, or a copolymer of three or more units comprising those two structural units and one or more structural units derived from other monomers.

The fluorine-containing polymer (a) may be a polymer consisting of those selected from the norbornene derivatives (m2-1a) and (m2-1b) (for example, a polymer prepared by metathesis polymerization using a metallic catalyst), a polymer prepared by ring-opening polymerization using the norbornene derivatives (m2-1a) and (m2-1b) or a hydrogenated polymer thereof.

Also the fluorine-containing polymer (a) may be a copolymer of the norbornene derivatives (m2-1a) and (m2-1b) with an ethylenic monomer, for example, α-olefins such as an acrylic monomer, maleic acid derivative, ethylene, propylene and vinyl chloride, fluorine-containing olefins and the like.

Among them, preferred as a fluorine-containing polymer for a resist are a copolymer consisting of the structural units (M2-1a) and (M2-1B) derived from the norbornene derivatives, a copolymer comprising the mentioned copolymer and a structural unit derived from an acrylic monomer, and a copolymer comprising the mentioned copolymer and a structural unit derived from a fluorine-containing olefin. Those copolymers are preferred because transparency and dry etching resistance are excellent.

Particularly preferred are copolymers which comprise the norbornene derivatives ((m2-1a) and (m2-1b)) and one or more of fluorine-containing olefins and are transparent to light having a short wavelength of 157 nm.

Concretely the fluorine-containing polymer (a) is the fluorine-containing polymer represented by the formula (M-1):
-(M1)-(M2-1a)-(M2-1B)-(N)- (M-1)
wherein the structural unit M1 is the structural unit derived from the fluorine-containing ethylenic monomer (m1) having 2 or 3 carbon atoms and at least one fluorine atom; the structural unit M2-1a is the structural unit derived from the norbornene derivative (m2-1a) having OH group which has the moiety represented by the mentioned formula (1); the structural unit M2-1B is the structural unit derived from the norbornene derivative (m2-1b) having protective group which has the moiety represented by the mentioned formula (2); the structural unit N is the repeat unit derived from the monomer (n) copolymerizable with the monomers (m1), (m2-1a) and (m2-1b); the structural units M1, M2-1A, M2-1B and N are contained in amounts of from 24 to 70% by mole, from 1 to 69% by mole, from 1 to 69% by mole and from 0 to 20% by mole, respectively, and when (M1)+(M2-1A) +(M2-1B) is assumed to be 100% by mole, a percent by mole ratio of (M1)/((M2-1A)+(M2-3B)) is 30/70 to 70/30.

In the fluorine-containing polymer of the formula (M-1), the structural unit M1 is obtained from a fluorine-containing ethylenic monomer and is preferred because good transparency can be imparted to the polymer, particularly an effect of enhancing transparency to ultraviolet light having a short wavelength (for example, 157 nm) can be imparted to the polymer.

Examples of the monomer introducing the structural unit M1 are:
CF₂═CF₂, CF₂═CFCl, CH₂═CF₂, CFH═CH₂, CFH═CF₂, CF₂═CFCF₃, CH₂═CFCF₃, CH₂═CHCF₃
   and the like.

Among them, tetrafluoroethylene (CF₂═CF₂) and chlorotrifluoroethylene (CF₂═CFCl) are preferred from the viewpoint of good copolymerizability and a high effect of imparting transparency.

The structural unit M2-1A is the structural unit derived from the norbornene derivative (m2-1a) having OH group which has the moiety represented by the mentioned formula (1). Namely, the structural unit M2-1A may be one, in which, for example, a hydrogen atom bonded to the carbon atom forming the norbornene backbone is replaced by a substituent containing the moiety represented by the formula (1): 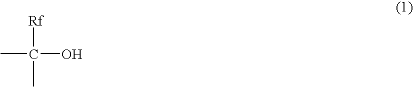
wherein Rf is a fluorine-containing alkyl group having 1 to 5 carbon atoms, or the moiety of the formula (1) may be contained in the norbornene backbone.

Preferred as the norbornene derivative (m2-1a) having OH group which has the moiety of the formula (1) is the norbornene derivative represented by the formula (m2-2a): 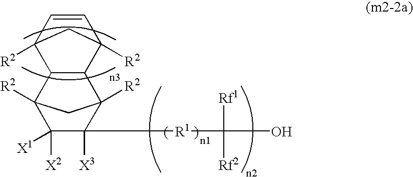
wherein X³ is selected from hydrogen atom, fluorine atom or CF₃, and when n2 is 0, X³ is CF₃; X¹ and X² are the same or different and each is hydrogen atom or fluorine atom; R¹ is at least one divalent hydrocarbon group selected from divalent hydrocarbon groups which have 1 to 5 carbon atoms and may have ether bond and divalent hydrocarbon groups which have 1 to 5 carbon atoms and may have ether bond, in which a part or the whole of hydrogen atoms are substituted with fluorine atoms; Rf¹ and Rf² are the same or different and each is a fluorine-containing alkyl group having 1 to 5 carbon atoms; R² are the same or different and each is hydrogen atom or an alkyl group having 1 to 10 carbon atoms; n1 and n2 are the same or different and each is 0 or 1; n3 is 0 or an integer of from 1 to 5.

The first preferred norbornene derivative of the formula (m2-2a) is a norbornene derivative having OH group which is represented by the formula (m2-3a): 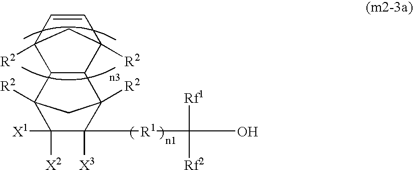
wherein X³ is selected from hydrogen atom, fluorine atom or CF₃; X¹ and X² are the same or different and each is hydrogen atom or fluorine atom; R¹ is at least one divalent hydrocarbon group selected from divalent hydrocarbon groups which have 1 to 5 carbon atoms and may have ether bond and divalent hydrocarbon groups which have 1 to 5 carbon atoms and may have ether bond, in which a part or the whole of hydrogen atoms are substituted with fluorine atoms; n1 is 0 or 1; Rf¹ and Rf² are the same or different and each is a fluorine-containing alkyl group having 1 to 5 carbon atoms; R² are the same or different and each is hydrogen atom or an alkyl group having 1 to 10 carbon atoms; n3 is 0 or an integer of from 1 to 5, in which, for example, a hydrogen atom bonded to the carbon atom forming the norbornene backbone is replaced by a substituent containing the moiety represented by the formula (1).

Particularly preferred is a norbornene derivative having OH group which is represented by the formula (m2-4a): 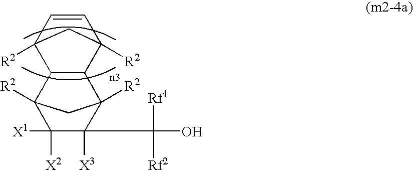
wherein X³ is selected from hydrogen atom, fluorine atom or CF₃; X¹ and X² are the same or different and each is hydrogen atom or fluorine atom; Rf¹ and Rf² are the same or different and each is a fluorine-containing alkyl group having 1 to 5 carbon atoms; R² are the same or different and each is hydrogen atom or an alkyl group having 1 to 10 carbon atoms; n3 is 0 or an integer of from 1 to 5.

The fluorine-containing polymers (a) having OH group which are obtained using those norbornene derivatives are particularly preferred because a rate of dissolution in a developing solution, namely resolution can be improved effectively by the method of introducing protective group of the present invention.

In the formula (m2-3a), it is preferable, from the viewpoint of excellent transparency and excellent solubility in a developing solution of the polymer, that at least one of X¹, X² and X³ is F or CF₃.

Further preferred as the norbornene derivative of the formula (m2-3a) is a norbornene derivative having OH group which is represented by the formula (m2-5a): 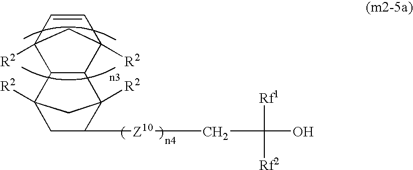
wherein Z¹⁰ is oxygen atom or —CH₂O—; n4 is 0 or 1; Rf¹, Rf², R² and n3 are as defined in the formula (m2-2a).

In the formulae (m2-2a), (m2-3a), (m2-4a) and (m2-5a), preferred examples of Rf¹ and Rf² are the same as those exemplified in the formula (1).

In the formulae (m2-2a), (m2-3a), (m2-4a) and (m2-5a), each of R² is selected from hydrogen atom or an alkyl group having 1 to 10 carbon atoms and may be the same or different. Among them, hydrogen atom or CH₃ are preferred, and particularly preferred is hydrogen atom.

Examples of the OH group-containing norbornene derivatives of the formula (m2-4a) are, for instance, 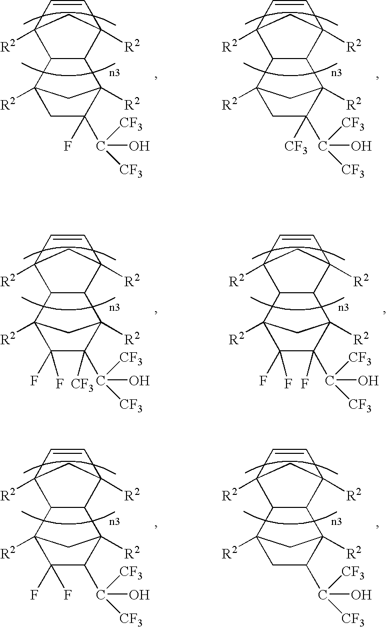
and the like, wherein R² are as defined in the formula (m2-3a), n3 is 0 or an integer of from 1 to 5.

More concretely there are preferably: 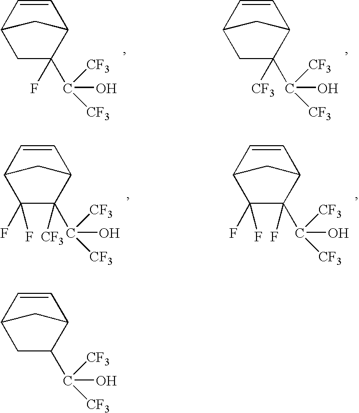
and the like.

It is preferable that the fluorine-containing polymer (a) used in the method of forming a pattern of the present invention has the structural unit derived from the fluorine-containing norbornene derivatives having OH group mentioned supra, thereby making it possible to effectively provide the polymer with transparency in a vacuum ultraviolet region, dry etching resistance and solubility in a developing solution which are necessary for a resist.

In the formula (m2-4a), preferred is the OH group-containing norbomene derivative, in which X¹ and X² are H and X³ is F or CF₃, the norbornene derivative having a fluorine-containing alcohol structure, in which X¹ and X² are F and X³ is F or CF₃, or the OH group-containing norbornene derivative, in which Rf¹ and Rf² are CF₃.

Examples of the OH group-containing norbomene derivatives represented by the formula (m2-5a) are, for instance, 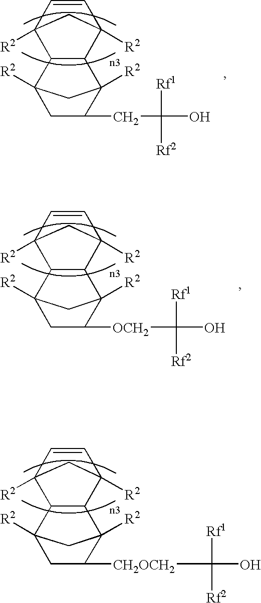
and the like, wherein R², Rf¹, Rf² and n3 are as defined in the formula (m2-4a).

More concretely there are preferably: 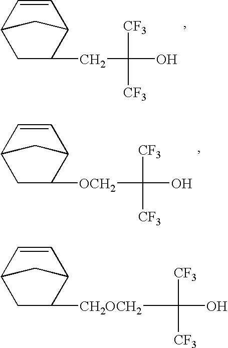
and the like.

The secondarily preferred norbornene derivative of the formula (m2-2a) is a OH group-containing norbornene derivative, in which the moiety of the formula (1) having OH group is contained in the norbornene backbone, and is concretely represented by the formula (m2-6a): 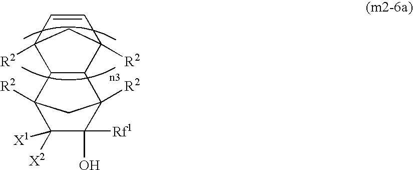
wherein X¹, X², R², Rf¹ and n3 are as defined in the formula (m2-2a).

Examples of the OH group-containing norbornene derivatives represented by the formula (m2-6a) are, for instance, 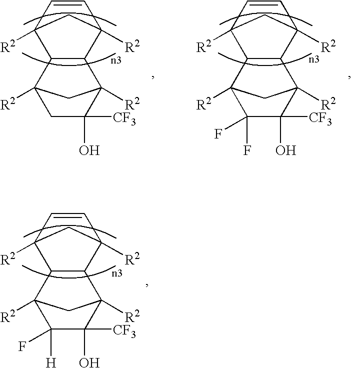
and the like, wherein R² and n3 are as defined in the formula (m2-2a).

More concretely there are: 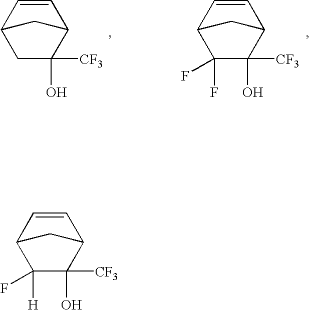
and the like.

In the polymer of the formula (M-1), the structural unit (M2-1B) having protective group is the structural unit derived from the norbornene derivative (m2-1b) having the moiety of the formula (2), and like the structural unit (M2-1A), the structural unit M2-1B may be one, in which, for example, a hydrogen atom bonded to the carbon atom forming the norbornene backbone is replaced by a substituent containing the moiety represented by the formula (2): 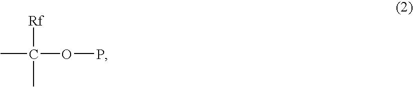
wherein Rf is a fluorine-containing alkyl group having 1 to 5 carbon atoms; —O—P is a protective group which is converted to OH group due to reaction with an acid, and examples thereof are the same as mentioned supra, or the moiety of the formula (2) may be contained in the norbornene backbone.

Preferred examples of the structural unit (M2-1B) having protective group are the same as the OH group-containing norbornene derivatives of the above-mentioned formula (m2-2a), in which the OH group is substituted with the protective group —O—P.

Namely, the structural unit M2-1B is a structural unit derived from a norbornene derivative represented by the formula (m2-2b): 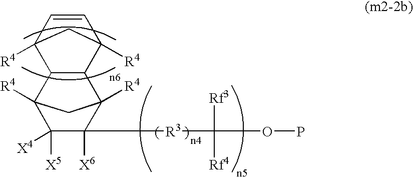
wherein —O—P is a protective group which can be converted to OH group by dissociation reaction with an acid, and —P is represented by the formula (2-1); X⁶ is selected from hydrogen atom, fluorine atom or CF₃, and when n5 is 0, X⁶ is CF₃; X⁴ and X⁵ are the same or different and each is hydrogen atom or fluorine atom; R³ is at least one divalent hydrocarbon group selected from divalent hydrocarbon groups which have 1 to 5 carbon atoms and may have ether bond and divalent hydrocarbon groups which have 1 to 5 carbon atoms and may have ether bond, in which a part or the whole of hydrogen atoms are substituted with fluorine atoms; Rf³ and Rf⁴ are the same or different and each is a fluorine-containing alkyl group having 1 to 5 carbon atoms; R⁴ are the same or different and each is hydrogen atom or an alkyl group having 1 to 10 carbon atoms; n4 and n5 are the same or different and each is 0 or 1; n6 is 0 or an integer of from 1 to 5.

The norbornene derivatives of the formulae (m2-3a), (m2-4a), (m2-5a) and (m2-6a), in which the OH group is substituted with the protective group —O—P, can be used as preferred examples of the norbornene derivative (m2-2b) having protective group.

The norbornene derivative having protective group which is obtained by substituting the OH group of the OH group-containing norbornene derivative of the formula (m2-3a) with the protective group —O—P is assumed to be represented by the formula (m2-3b). Similarly the norbornene derivatives having protective group which are obtained by substituting the OH group of the OH group-containing norbornene derivatives of the formulae (m2-4a), (m2-5a) and (m2-6a) with the protective group —O—P are assumed to be represented by the formulae (m2-4b), (m2-5b) and (m2-6b), respectively.

The mentioned examples of the norbornene derivatives of the formulae (m2-3a), (m2-4a), (m2-5a) and (m2-6a), in which the OH group is replaced by the protective group —O—P, can be used preferably as the examples of the norbornene derivatives having protective group of the formulae (m2-3b), (m2-4b), (m2-5b) and (m2-6b).

The protective group —O—P in those exemplified norbornene derivatives having protective group is characterized by containing the mentioned specific bicyclo saturated hydrocarbon W, and there are raised the same protective groups as exemplified supra.

In the fluorine-containing polymer of the formula (M-1), the structural unit N is the structural unit derived from the monomer (n) which is copolymerizable with the monomers (m1), (m2-1a) and (m2-1b) introducing the structural units M1, M2-1A and M2-1B, respectively, and is an optional component.

The first preferred structural unit N is a structural unit (N2) derived from a norbornene derivative (n2) which may contain fluorine atom other than the structural units M2-1A and M2-1B.

Examples thereof are, for instance, norbornenes (n2-1) which do not have functional group and may have fluorine atom or norbornenes having functional group, namely norbornenes which have a moiety having OH group except the moiety of the formula (1) or (2) or have functional group other than OH group.

Examples of the norbornenes (n2-1) having no functional group are: 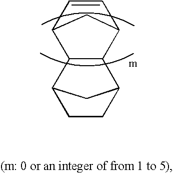 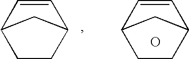
and monomers of the formula (n2-1a): 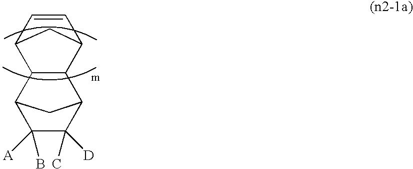
wherein each of A, B, C and D is hydrogen atom, fluorine atom, an alkyl group having 1 to 10 carbon atoms or a fluorine-containing alkyl group having 1 to 10 carbon atoms; m is 0 or an integer of from 1 to 5; any one of A to D has fluorine atom. Examples of the monomers of the formula (n2-1a) are: 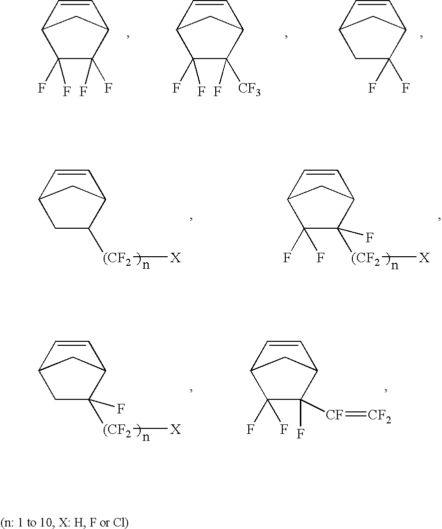
and the like.

In addition, there are: 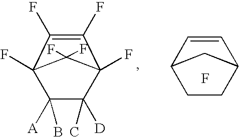
and the like, wherein A, B, C and D are as defined above.

The introduction of the structural unit derived from the monomer (n2-1) is preferred since dry etching resistance as well as transparency can be further enhanced.

Also the introduction of the structural unit derived from the monomer (n2-1) is preferred since the contents of structural unit M2-1A of the OH group-containing norbornene derivative and structural unit M2-1B of the norbornene derivative having protective group can be adjusted without lowering dry etching resistance.

Among the norbornene derivatives having functional group, particularly preferred are norbornene derivatives (n2-2) having carboxylic acid or carboxylic acid derivative thereof (—COOY²), in which a protective group to be dissociated by an acid is introduced to the carboxylic acid. Examples thereof are: 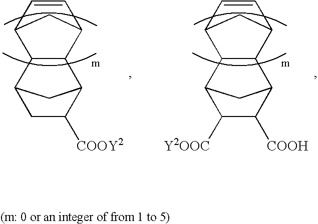
and 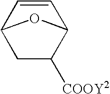
and also the monomer (n2-2) may be one, in which a part or the whole of hydrogen atoms are substituted with fluorine atoms since further transparency can be imparted to the polymer.

There are concretely fluorine-containing monomers represented by: 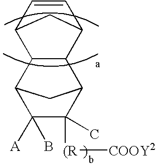
wherein each of A, B and C is hydrogen atom, fluorine atom, an alkyl group having 1 to 10 carbon atoms or a fluorine-containing alkyl group having 1 to 10 carbon atoms; R is a divalent hydrocarbon group having 1 to 20 carbon atoms, a fluorine-containing alkylene group having 1 to 20 carbon atoms or a fluorine-containing alkylene group having 2 to 100 carbon atoms and ether bond; a is 0 or an integer of from 1 to 5; b is 0 or 1; COOY² is COOH group or an acid-labile functional group which can be converted to carboxyl group by an acid; when b is 0 or R does not have fluorine atom, any one of A to C is a fluorine atom or a fluorine-containing alkyl group.

In those monomers, it is preferable that any of A, B and C is a fluorine atom, and when fluorine atom is not contained in A, B and C, it is preferable that the fluorine content of R is not less than 60%. It is further preferable that R is a perfluoroalkylene group since transparency can be imparted to the polymer.

Concretely there are: 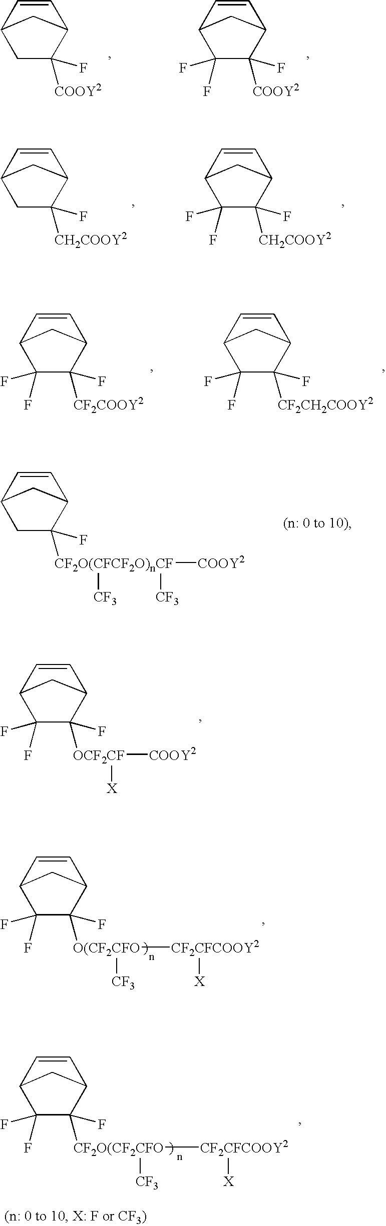
and the like.

Also there are fluorine-containing monomers represented by: 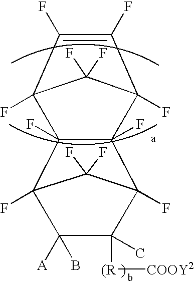
wherein each of A, B and C is hydrogen atom, fluorine atom, an alkyl group having 1 to 10 carbon atoms or a fluorine-containing alkyl group having 1 to 10 carbon atoms; R is a divalent hydrocarbon group having 1 to 20 carbon atoms, a fluorine-containing alkylene group having 1 to 20 carbon atoms or a fluorine-containing alkylene group having 2 to 100 carbon atoms and ether bond; a is 0 or an integer of from 1 to 5; b is 0 or 1; COOY² is COOH group or an acid-labile functional group which can be converted to carboxyl group by an acid.

Concretely there are preferably monomers having norbornene backbone such as:

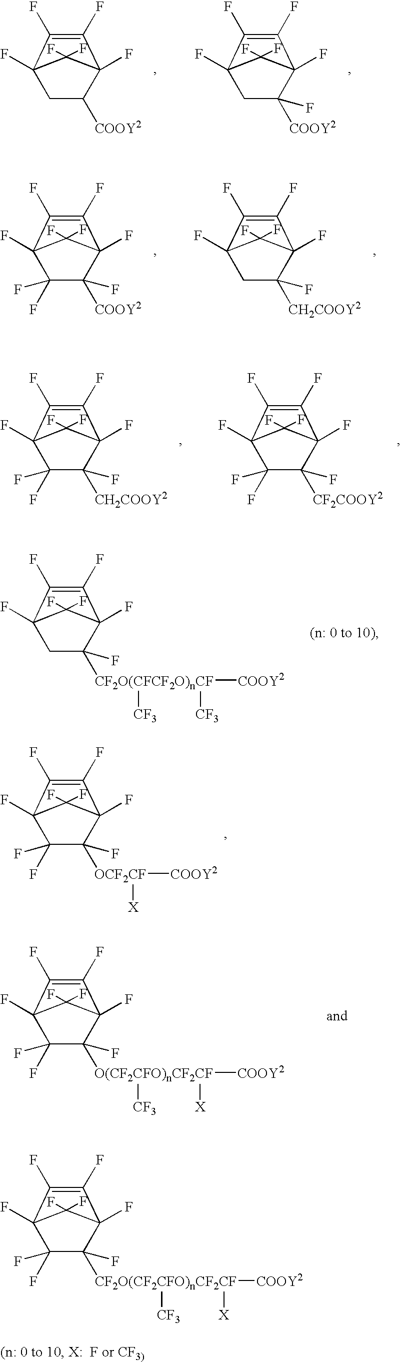

In the above-exemplified norbornene derivatives (n2-2) having the carboxylic acid derivative (—COOY²), Y² is one selected from hydrocarbon groups having tertiary carbon which can be bonded directly to carboxyl group. For example, there are t-butyl group, 1,1-dimethylpropyl group, adamantyl group, organic group having the mentioned bicyclo saturated aliphatic hydrocarbon group, organic group having monocyclic saturated aliphatic hydrocarbon, methyl adamantyl group, ethyl adamantyl group and the like, and preferred is t-butyl group since acid dissociation reactivity is particularly excellent.

The monomers (n2-2) exemplified above are copolymerizable with the monomers for the structural units M1, M2-1A and M2-1B, and further have COOH group or the acid-labile functional group COOY² which can be converted to carboxyl group by an acid. Therefore, introduction of the structural unit derived from the monomer (n2-2) is preferred since a function of giving solubility in an aqueous alkaline solution (developing solution) can be further enhanced and at the same time, dry etching resistance of the whole polymer can be enhanced more.

The secondarily preferred structural unit N is the structural unit (N1) derived from the monomer (n1) copolymerizable with the monomers (m1), (m2-1a), (m2-1b) and (n2) for the structural units M1, M2-1A, M2-1B and N2.

The first preferred examples of the structural unit N1 is the structural unit N1-1 derived from an ethylenic monomer which has COOH group or a carboxylic acid derivative thereof (COOY¹), in which a protective group to be dissociated by an acid is introduced to the carboxylic acid. The structural unit N1-1 is represented by the formula N1-1: 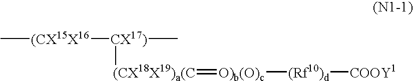
and is derived from an ethylenic monomer represented by the formula (n1-1): 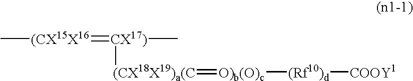
wherein COOY¹ is COOH group or a group, in which a protective group to be dissociated by an acid is introduced to the carboxylic acid; X¹⁵ and X¹⁶ are the same or different and each is hydrogen atom or fluorine atom; X¹⁷ is hydrogen atom, fluorine atom, Cl, CH₃ or CF₃; X¹⁸ and X¹⁹ are the same or different and each is hydrogen atom, fluorine atom or CF₃; Rf¹⁰ is a fluorine-containing alkylene group having 1 to 40 carbon atoms or a fluorine-containing alkylene group having 2 to 100 carbon atoms and ether bond; a is 0 or an integer of from 1 to 3; b, c and d are the same or different and each is 0 or 1. The monomer (n1-1) may contain or may not contain fluorine atom.

Examples of the monomer (n1-1) having no fluorine atom (d=0) are:

Acrylic monomers:

CH₂═CHCOOY¹, CH₂═C(CH₃)COOY¹,
CH₂═CClCOOY¹,
   Maleic acid monomers: 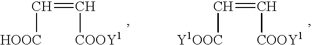
   Allyl monomers:
CH₂═CHCH₂COOY¹, CH₂═CHCH₂OCH₂CH₂COOY¹
   and the like.

Examples of the monomer (n1-1) having fluorine atom in its trunk chain (d=0) are:

Fluorine-containing acrylic monomers:

CH₂═CFCOOY¹, CH₂═C(CF₃)COOY¹, CF₂═CFCOOY¹ and CF₂═C(CF₃)COOY¹
   Fluorine-containing allyl monomers:
CH₂═CFCF₂COOY¹, CF₂═CFCF₂COOY¹ and CH₂═CHCF₂COOY¹,
   and the like.

Preferred examples of the monomer (n1-1) having a fluoroalkyl group in its side chain (d=1) are monomers represented by the formula (n1-1-1):
CH₂═CFCF₂O—Rf¹⁰—COOY¹ (n1-1-1)
wherein COOY¹ and Rf¹⁰ are as defined in the above-mentioned formula (n1-1), and there are concretely: 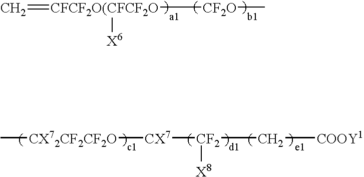
wherein a1+b1+c1 is from 0 to 30, d1 is 0 or 1, e1 is from 0 to5, X⁶ is fluorine atom or CF₃, X⁷ is hydrogen atom or fluorine atom, X⁸ is hydrogen atom, fluorine atom or CF₃.
More concretely there are: 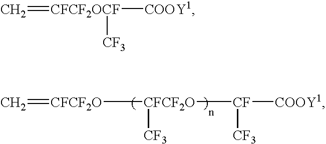
(n is an integer of from 1 to 30)
CH₂═CFCF₂O [symbol] CF₂CF₂O [symbol] ₙCF₂—COOY¹,
CH₂═CFCF₂O [symbol] CF₂CF₂CF₂O [symbol] ₙCF₂CF₂—COOY¹,
CH₂═CFCF₂O [symbol] CH₂CF₂CF₂O [symbol] ₙCH₂CF₂—COOY¹,
CH₂═CFCF₂O [symbol] CF₂CF₂ [symbol] ₙCOOY¹,
   (n is an integer of from 1 to 30)
   and the like.

Also there are preferably monomers represented by the formula (n1-1-2):
CF₂═CFO—Rf¹⁰—COOY¹ (n1-1-2)
wherein COOY¹ and Rf¹⁰ are as defined in the above-mentioned formula (n1-1). The monomers of the formula (n 1-1-2) are concretely represented by: 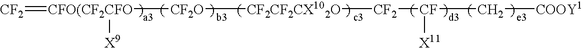
wherein a3+b3+c3 is from 0 to 30, d3 is 0, 1 or 2, e3 is from 0 to 5, X⁹ and X¹¹ are fluorine atom or CF₃, X¹⁰ is hydrogen atom or fluorine atom.
More concretely there are:
CF₂═CFOCF₂CF₂—COOY¹, 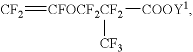
CF₂═CFO [symbol] (CF₂ [symbol] ₃COOY¹,
CF₂═CFOCF₂CF₂OCF₂COOY¹,
CF₂═CFOCF₂CF₂CH₂OCF₂CF₂—COOY¹,
   and the like.

Other examples of the monomer (n1-1) are, for instance:
CF₂═CFCF₂—O—Rf¹⁰—COOY¹, CF₂═CF—Rf¹⁰—COOY¹,
CH₂═CH—Rf¹⁰—COOY¹, CH₂═CHO—Rf¹⁰—COOY¹,
(Rf¹⁰ is the same as Rf¹⁰ of the formula (n1-1))
   and the like. More concretely there are:
CF₂═CF—CF₂OCF₂CF₂CF₂COOY¹, 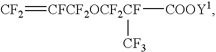
CF₂═CFCF₂—COOY¹, CH₂═CHCF₂CF₂—COOY¹,
CH₂═CHCF₂CF₂CH₂COOY¹,
CH₂═CHCF₂CF₂CF₂CF₂—COOY¹,
CH₂═CHCF₂CF₂CF₂CF₂CH₂COOY¹,
CH₂═CH₂O—CH₂CF₂CF₂—COOY¹,
CH₂═CH₂OCH₂CF₂CF₂CH₂COOY¹,
   and the like.

Examples of the Y¹ in the above-exemplified ethylenic monomers (n1-1) having the carboxylic acid derivative (COOY¹) are preferably the same as those of Y² in the norbornene derivatives (n2-2) having carboxylic acid derivative (—COOY²).

The above-exemplified monomers (n1-1) are copolymerizable with the monomers introducing the structural units M1, M2-1A, M2-1B and N2 and have COOH group or an acid-labile functional group COOY¹ which can be converted to carboxyl group by an acid. Therefore, introduction of the structural unit derived from the monomer (n1-1) is preferred since a function of giving solubility in an aqueous alkaline solution (developing solution) can be further enhanced.

Examples of the other ethylenic monomer (n1-2) introducing the structural unit N1 are:
Acrylic monomers (excluding monomers introducing the structural unit N1-1): 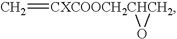
CH₂═CXCOOH,
CH₂═CXCOOCH₂CH₂OH and 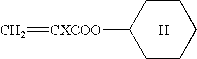
(X is selected from hydrogen atom, CH₃, fluorine atom and CF₃)
   Ethylene monomers:
CH₂═CH₂, CH₂═CHCH₃, CH₂═CHCl and the like.
   Maleic acid monomers: 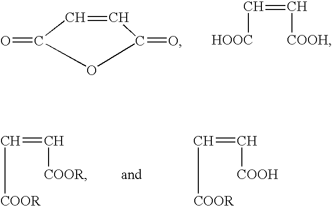
   wherein R is a hydrocarbon group having 1 to 20 carbon atoms.
   Allyl monomers:
CH₂═CHCH₂Cl, CH₂═CHCH₂OH, CH₂═CHCH₂COOH, CH₂═CHCH₂Br and the like.
   Allyl ether monomers: 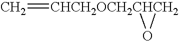
   Other monomers:
CH₂═CHO—R, 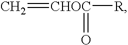
(R is an alkyl group which has 1 to 20 carbon atoms and may be substituted with fluorine)
   More concretely there are: 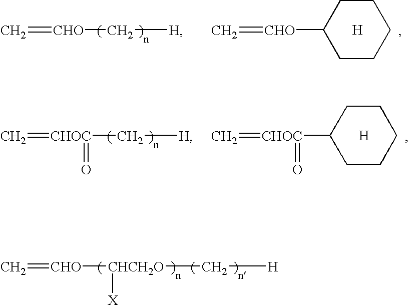
   (n: from 1 to 20, n′: from 0 to 5, X: H or CH₃),
   and the like.

Those exemplified optional structural units N are optionally selected depending on purposes for improving solubility of the polymer in a developing solution (resolution), controlling water repellency, imparting heat resistance and improving solubility in a solvent and film forming property, and are introduced to the polymer.

The fluorine-containing polymer of the formula (M-1) contains the structural units M1, M2-1A, M2-1B and N in amounts of from 24 to 70% by mole, from 1 to 69% by mole, from 1 to 69% by mole and from 0 to 20% by mole, respectively. When (M1)+(M2-1A)+(M2-1B) is assumed to be 100% by mole, a percent by mole ratio of (M1)/((M2-1A)+(M2-1B)) is 30/70 to 70/30.

The percent by mole ratio of (M1)/((M2-1A)+(M2-1B)) is preferably 35/65 to 65/35, more preferably 40/60 to 60/40, further preferably 40/60 to 50/50.

Too large proportion of the structural unit M1 is not preferred since solubility in a developing solution after the acid dissociation is lowered, and too small proportion of the structural unit M1 is not preferred since transparency to light of 157 nm is lowered.

The optional structural unit N is introduced, as case demands, for the purposes for improving solubility of the polymer in a developing solution (resolution), controlling water repellency, imparting heat resistance and improving solubility in a solvent and film forming property, preferably within limits not lowering transparency and dry etching resistance.

Therefore it is desirable not to introduce the structural unit N as far as possible. Even if the structural unit N is introduced, it is preferable that the proportion thereof is small, for example, preferably not more than 10% by mole, more preferably not more than 5% by mole based on the whole structural units.

In the fluorine-containing polymer of the formula (M-1), when (M2-1A)+(M2-1B) is assumed to be 100% by mole, a percent by mole ratio of (M2-1A)/(M2-1B) is preferably 40/60 to 90/10, more preferably 50/50 to 85/15, particularly preferably 60/40 to 85/15, further preferably 65/35 to 80/20. Too large proportion of the structural unit (M2-1A) is not preferred because an un-exposed portion is dissolved by developing and a thickness of the un-exposed portion is decreased too much. Too large proportion of the structural unit (M2-1B) is not preferred because resolution becomes insufficient and the pattern becomes T-top in shape.

The number average molecular weight of the fluorine-containing polymer of the formula (M-1) is not less than 1,000, preferably not less than 2,000, more preferably not less than 3,000, and the upper limit thereof is 100,000, preferably 50,000, more preferably 10,000. The weight average molecular weight thereof is not less than 2,000, more preferably not less than 3,000, and the upper limit thereof is 200,000, preferably 50,000, more preferably 10,000.

In the present invention, the structural unit (M2-1B) of the protective-group-containing norbornene derivative may be introduced to the fluorine-containing polymer (a) having protective group which is used for a resist, by a method (polymer reaction method) of first synthesizing a fluorine-containing polymer having OH group through polymerization reaction using the OH-containing norbornene derivative (m2-1a) and then introducing the protective group (—O—P) of the present invention through polymer reaction, or by a method (copolymerization method) of first synthesizing the protective-group-containing norbornene derivative (m2-1b) and then carrying out polymerization reaction using the OH-containing norbornene derivative (m2-1a) and the protective-group-containing norbornene derivative (m2-1b).

Particularly preferred is the method of introducing the protective group (—O—P) of the present invention through polymer reaction using a fluorine-containing polymer having OH group since it is easy to control a composition ratio (protection ratio) and molecular weight of the polymer.

In the present invention, the fluorine-containing polymer (a) having protective group which is used for a resist is excellent in transparency at a wavelength of 157 nm, and it is preferable that the polymer has an absorption coefficient at 157 nm of not more than 2.0 μm⁻¹, preferably not more than 1.5 μm⁻¹, particularly preferably not more than 1.0 μm⁻¹, further preferably not more than 0.5 μm⁻¹. The polymer is preferred since as the absorption coefficient at a wavelength of 157 nm decreases, a good resist pattern can be formed when the polymer is used for a F₂ photoresist composition.

In the step (I) of the method of forming a fine pattern of the present invention, by using the fluorine-containing polymer (a) explained supra, the resist composition comprising:
(a) the fluorine-containing polymer having protective group,
(b) a photoacid generator, and
(c) a solvent is prepared.

In the resist composition of the present invention, there are preferably exemplified the same photoacid generators (b) as the photoacid generators (b) raised in International Publication No. 01/74916. Those photoacid generators can also be used effectively in the present invention.

The photoacid generator is a compound which generates acid or cation by irradiation of light. Examples thereof are, for instance, organic halogen compounds, sulfonic acid esters, onium salts (particularly fluoroalkyl onium salts having iodine, sulfur, selenium, tellurium, nitrogen or phosphorus as a center element), diazonium salts, disulfone compounds, sulfonediazides and a mixture thereof.

More preferred examples thereof are as follows.
(1) TPS Compound: 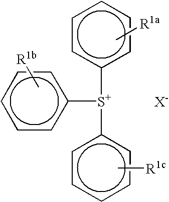
wherein X⁻ is PF₆⁻, SbF₆⁻, CF₃SO₃⁻, C₄F₉SO₃⁻ or the like; R^{1a}, R^{1b} and R^{1c} are the same or different and each is CH₃O, H, t-Bu, CH₃, OH or the like.
(2) DPI Compound: 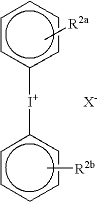
wherein X⁻ is CF₃SO₃⁻, C₄F₉SO₃⁻, CH₃—φ—SO₃⁻, SbF₆⁻, 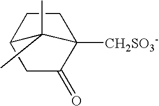
or the like; R^{2a} and R^{2b} are the same or different and each is hydrogen atom, OH, CH₃, CH₃O, t-Bu or the like.
(3) Sulfonate Compound: 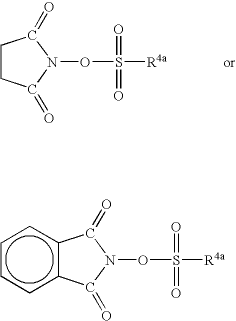
wherein R^{4a} is: 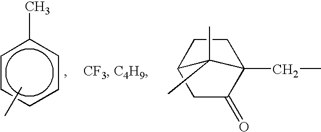
or the like.

The content of photoacid generator (b) used for the photoresist composition in the present invention is preferably from 0.1 to 30 parts by weight, more preferably from 0.2 to 20 parts by weight, most preferably from 0.5 to 10 parts by weight based on 100 parts by weight of the fluorine-containing polymer (a) having protective group.

If the content of photoacid generator (b) is lower than 0.1 part by weight, sensitivity is lowered, and if the content of photoacid generator (b) is higher than 30 parts by weight, an amount of light absorbed by the photoacid generator is increased and light does not reach a substrate sufficiently and therefore resolution tends to be lowered.

Also to the resist composition of the present invention may be added an organic base being capable of acting as a base on an acid generated from the photoacid generator (b). Examples of preferred organic base are the same as those exemplified in International Publication No. 01/74916. Those organic bases can also be used effectively in the present invention.

The organic base is an organic amine compound selected from nitrogen-containing compounds. Examples thereof are, for instance, pyridine compounds, pyrimidine compounds, amines substituted by hydroxyalkyl group having 1 to 4 carbon atoms, amino phenols and the like. Particularly preferred are amines having hydroxyl.

Preferred examples thereof are butylamine, dibutylamine, tributylamine, triethylamine, tripropylamine, triamylamine, pyridine and the like.

The content of organic base used for the photoresist composition of the present invention is preferably from 0.1 to 100% by mole, more preferably from 1 to 50% by mole based on the content of photoacid generator (b). If the content of organic base is lower than 0.1% by mole, resolution is lowered, and if the content of organic base is higher than 100% by mole, sensitivity tends to be lowered.

The resist composition of the present invention may contain, as case demands, additives disclosed in International Publication No. 01/74916, for example, various additives which have been usually used in this field, such as dissolution inhibitor, sensitizer, dye, adhesion betterment material and water storage material.

Also in the resist composition of the present invention, examples of preferred solvent (c) are the same as those of the solvent (c) exemplified in International Publication No. 01/74916. Those solvents can also be used effectively in the present invention.

Preferred examples thereof are cellosolve solvents, ester solvents, propylene glycol solvents, ketone solvents, aromatic hydrocarbon solvents and solvent mixtures thereof. Also in order to enhance solubility of the fluorine-containing polymer (a) having protective group, fluorine-containing solvents, namely, fluorine-containing hydrocarbon solvents such as CH₃CCl₂F (HCFC-141b) and fluorine-containing alcohols may be used together.

The amount of the solvent (c) is selected depending on kind of solids to be dissolved, kind of a substrate to be coated, intended coating thickness, etc. From the viewpoint of easy coating, it is preferable that the solvent is used in such an amount that the concentration of the whole solids of the photoresist composition becomes from 0.5 to 70% by weight, preferably from 1 to 50% by weight.

In the step (I) for preparing the resist composition of the present invention, the above-mentioned fluorine-containing polymer (a) having protective group, the photoacid generator (b) and the additives to be blended as case demands are dissolved uniformly in the solvent (c).

The thus obtained liquid composition may be subjected to filtration if necessary, thereby removing insoluble substances, for example, insoluble matters, particles, other foreign matters and dusts, etc. in the above-mentioned (a), (b) and (c).

Further as case demands, the composition may be subjected to ion exchanging to remove metals and metallic ions.

Mentioned below is the explanation of the method of forming a pattern of the step (II) to the step (IV) on reference to the drawing by using the resist composition of the present invention.

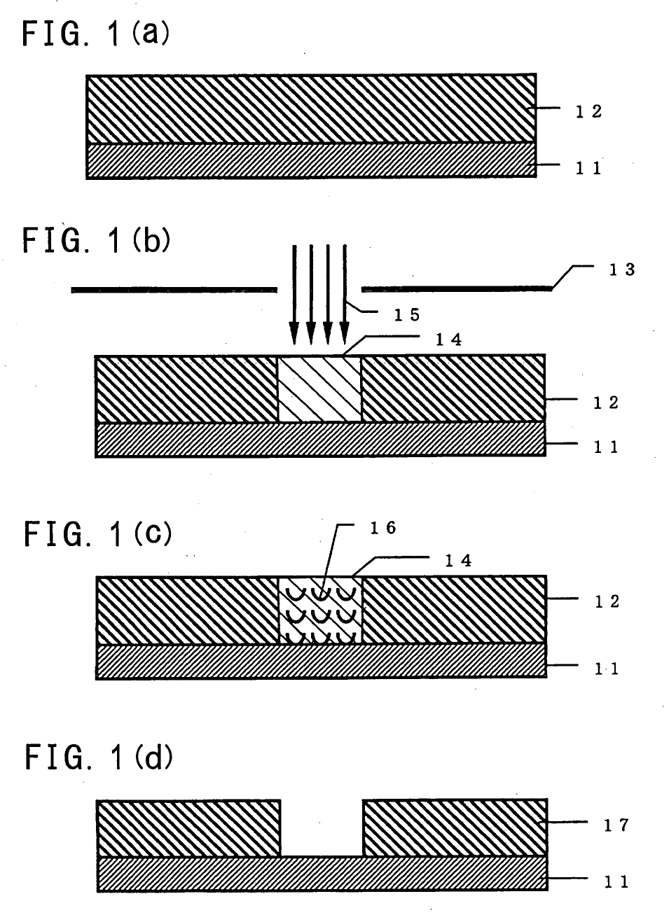

FIG. 1 is a cross-sectional view showing the method of forming a fine pattern of the present invention.

(II) Step for forming a resist film

First, as shown in FIG. 1(a), the resist composition obtained in the step (I) is coated on a substrate 11 by a rotary coating method or the like in a coating thickness of from 0.01 to 5 μm, preferably from 0.05 to 0.5 μm, more preferably from 0.1 to 0.3 μm.

Next, pre-baking treatment is carried out at a pre-determined temperature of not more than 150° C., preferably from 80° to 130° C. to form a resist layer 12.

Non-limiting examples of the above-mentioned substrate are, for instance, a silicon wafer, glass substrate, silicon wafer or glass substrate provided with organic or inorganic antireflection films, silicon wafer provided with insulation films, electrode and wiring on a surface thereof and having steps, mask blank, semiconductor wafer of III-V group compound such as GaAs and AlGaAs, semiconductor wafer of II-VI group compound, piezoelectric wafer of crystal, quartz or lithium tantalate and the like.

The coating film of the resist composition of the present invention is preferably one having high transparency in a vacuum ultraviolet region. Concretely it is preferable that an absorption coefficient at a wavelength of 157 nm is not more than 2.5 μm⁻¹, preferably not more than 2.0 μm⁻¹, particularly preferably not more than 1.50 μm⁻¹, further preferably not more than 1.0 μm⁻¹. This coating film can be used effectively for a lithography process using F₂ laser (157 nm). (III) Step for exposing

Then as shown in FIG. 1(b), a pattern is drawn on the resist layer 12 by irradiating energy ray, for example, F₂ excimer laser as shown by an arrow 15 through a mask 13 having a desired pattern, thus selectively exposing a specific area 14.

In that case, it is possible to carry out exposing of a pattern by using, as exposure light, energy ray (or chemical radiation), namely, X-ray, high energy electron beam, synchrotron radiation, characteristic radiation of high pressure mercury lamp, excimer laser other than F₂ laser or the like or to directly expose the resist film to the pattern by scanning with electron beam, ion beam or the like without using the mask. The effect of the present invention is exhibited most when F₂ laser is used as exposure light source.

Subsequently by carrying out baking at a temperature of from 70° to 160° C., preferably from 90° to 140° C., for about 30 seconds to about 10 minutes after the exposing, a latent image 16 is formed on the exposed area 14 of the resist film as shown in FIG. 1(c). At that time, an acid generated by the exposing acts as a catalyst to decompose the dissolution-inhibiting group (protective group), thereby increasing solubility in a developing solution and making the exposed area of the resist film soluble in a developing solution.

(IV) Step for developing

Then when the resist film 12 baked after the exposing is subjected to developing treatment with a developing solution, the un-exposed portion of the resist film 12 remains on the substrate because its solubility in the developing solution is low but the exposed area 14 is dissolved in the developing solution as mentioned above.

As a developing solution, an aqueous solution of 2.38% by weight of tetramethylammonium hydroxide is used preferably. Further in order to adjust wettability to the resist film, a surfactant and alcohol such as methanol, ethanol, propanol or butanol may be added to the aqueous solution of 2.38% by weight of tetramethylammonium hydroxide.

Next, after washing out the developing solution with pure water, lower alcohol or a mixture thereof, the substrate is dried and thus a desired resist pattern 17 can be formed as shown in FIG. 1(d).

While the above-mentioned explanation is made with respect to the case of using F₂ laser as the energy ray, ArF laser is also suitable as the energy ray used for the method of forming a fine pattern of the present invention.

Also KrF excimer laser is suitable as the energy ray used for the method of forming a fine pattern of the present invention.

High energy electron beam is also suitable as the energy ray used for the method of forming a fine pattern of the present invention.

Also high energy ion beam is suitable as the energy ray used for the method of forming a fine pattern of the present invention.

Also X-ray generated from synchrotron radiation is suitable as the energy ray used for the method of forming a fine pattern of the present invention.

Though the above-mentioned explanation is made with respect to the case of forming the resist film on the substrate 11, the formation of the resist film is not limited to the case of forming the resist film on a so-called substrate. The resist film may also be formed on a specific layer such as an electrically conductive film, insulating film or the like which is formed on the substrate. Also it is possible to form an antireflection film, for example, DUV-30, DUV-32, DUV-42 and DUV44 available from Brewer Science Co., Ltd. on the substrate. The resist film may be formed on a substrate treated with an adhesion improver, thus making it possible to enhance adhesion of the photosensitive composition to the substrate. The substrate is also not limited to those for production of semiconductor devices and includes various substrates for production of electronic devices as mentioned above.

Also semiconductor devices and electronic devices can be produced when an intended fine pattern of an electrically conductive film or an insulating film is formed by using the so-formed fine resist pattern as a mask and etching a specific layer under the mask and then other steps are carried out. Since those steps are well known, explanation thereof is omitted.

The present invention is then explained by means of examples, but is not limited to them.

### PREPARATION EXAMPLE 1

(Synthesis of Copolymer Comprising TFE and Norbornene Derivative (nb-1) Having OH Group)

A 3-liter autoclave equipped with a valve, pressure gauge, stirrer and thermometer was subjected to replacement with nitrogen gas several times and evacuation and was charged with 242 g of fluorine-containing norbornene derivative (nb-1) having OH group: 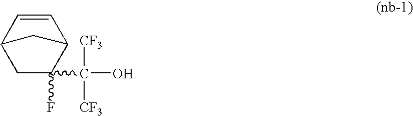
and 1.5 liter of HCFC-141b. Then 350 g of tetrafluoroethylene (TFE) gas was introduced through the valve and 102 g of perfluorohexane solution of 10.0% by weight of heptafluorobutanoyl peroxide: (CF₃CF₂CF₂COO)₂ was introduced to initiate reaction with stirring. The inside temperature was maintained at 30° C.

With the advance of the reaction, the inside pressure was decreased, and every time when the inside pressure was decreased from 0.9 MPaG (9.2 kgf/cm²G) before starting of the reaction to 0.85 MPaG (8.7 kgf/cm²G), TFE was additionally introduced to elevate the inside pressure to 0.9 MPaG (9.2 kgf/cm²G). Decreasing of the inside pressure due to the reaction and increasing of the inside pressure by additionally introducing TFE were repeated, and the polymerization reaction was continued for 30 hours.

During the polymerization, 51 g of perfluorohexane solution of 10.0% by weight of heptafluorobutanoyl peroxide: (CF₃CF₂CF₂COO)₂ was introduced five times, and further 12.1 g (5% of the initially charged amount) of fluorine-containing norbornene derivative (nb-1) having OH group was introduced ten times.

After completion of the reaction, the un-reacted monomer was released, and the polymerization solution was taken out, followed by concentration and re-precipitation with hexane to separate a copolymer. Until a constant weight was reached, vacuum drying was continued and 150 g of copolymer was obtained.

As a result of ¹H-NMR and ¹⁹F-NMR analyses, the copolymer was one comprising TFE and the above-mentioned OH group-containing norbornene derivative (NB-1) in a percent by mole ratio of 50/50.

According to GPC analysis, a weight average molecular weight of the copolymer was 4,500.

Equipment and measuring conditions used for evaluation of physical properties are as follows.

(1) NMR

NMR measuring equipment: available from BRUKER

Measuring conditions of ¹H-NMR: 300 MHz (tetramethylsilane=0 ppm)

Measuring conditions of ¹⁹F-NMR: 282 MHz (trichlorofluoromethane=0 ppm)

(2) A weight average molecular weight is calculated from the data measured by gel permeation chromatography (GPC) by using GPC HLC-8020 available from Toso Kabushiki Kaisha and columns available from Shodex (one GPC KF-801, one GPC KF-802 and two GPC KF-806M were connected in series) and flowing tetrahydrofuran (THF) as a solvent at a flowing rate of 1 ml/min.

### COMPARATIVE EXAMPLE 1

(Synthesis of Copolymer Comprising TFE, Norbornene Derivative (nb-1) Having OH Group and Norbornene Derivative (nb-2) Having OCH₂OCH₂CH₃ Group)

Reaction was carried out in the same manner as in Preparation Example 1 except that 160 g of (nb-1) and 100 g of norbornene derivative (nb-2) having —OCH₂OCH₂CH₃ group: 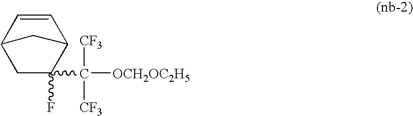
were used, and 8 g of (nb-1) and 5 g of (nb-2) were additionally introduced ten times. Thus 140 g of copolymer was obtained.

As a result of ¹H-NMR and ¹⁹F-NMR analyses, the copolymer was one comprising TFE, the above-mentioned norbornene derivative (NB-1) having OH group and the above-mentioned norbornene derivative (NB-2) having OCH₂OCH₂CH₃ group in a percent by mole ratio of 50/35/15.

According to GPC analysis, a weight average molecular weight thereof was 4,000.

### EXAMPLE 1

(Introduction of Protective Group Containing Bicyclo Saturated Hydrocarbon Structure W)

Into a one-liter four-necked flask equipped with a stirrer, thermometer and dropping funnel was poured 60 g of fluorine-containing polymer having OH group prepared in Preparation Example 1. After replacing the inside of a reaction system with N₂, 120 ml of N,N-dimethylformamide (DMF) was added to completely dissolve the fluorine-containing polymer having OH group.

Then 55.5 g (318 mmol) of chloromethyl 2-methyl norbornyl ether: 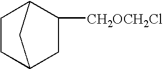
was added, and thereto was added dropwise 120 ml (862 mmol) of triethylamine so that the inside temperature became not more than 20° C. After completion of the addition, stirring was continued at room temperature for three hours.

After completion of the reaction, when 600 ml of pure water was added to the reaction mixture with stirring, a solid was precipitated, followed by allowing to stand and removing an upper solution layer by decantation. Then thereto was added 600 ml of pure water and the same procedures were repeated once. The precipitated solid was filtrated.

The solid was dissolved in 300 ml of ethyl acetate, followed by washing once with 150 ml of pure water. To the ethyl acetate layer was added 10 ml of acetic acid, followed by washing with 150 ml of pure water until a pH value became not less than 5.

To the washed ethyl acetate layer was added 50 ml of dioxane and the solvent was distilled off in a hot bath under reduced pressure to obtain a solid. The solid was dissolved in HCFC-141b, followed by re-precipitation in 1.5-liter of n-hexane, and the precipitated solid was separated by filtration. After vacuum drying, 34.4 g of fluorine-containing polymer (a) having protective group was obtained.

As a result of ¹H-NMR and ¹⁹F-NMR analyses, the fluorine-containing polymer (a) having protective group was a fluorine-containing polymer having a structural unit (NB-2-1) derived from a norbornene derivative having protective group and represented by the formula (NB-2-1): 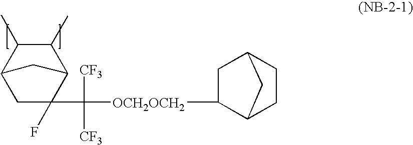
and also according to ¹⁹F-NMR analysis, the polymer was one comprising TFE, norbornene derivative (NB-1) having OH group and norbornene derivative (NB-2-1) having protective group in a percent by mole ratio of 50/33/17.

According to GPC analysis, a weight average molecular weight thereof was 3,200.

### EXAMPLE 2

(Introduction of Protective Group Containing Bicyclo Saturated Hydrocarbon Structure)

The same procedures as in Example 1 were carried out except that 23.0 g (131 mmol) of chloromethyl-2-methyl norbornyl ether was used, and 56.1 g of fluorine-containing polymer (a) having protective group was obtained.

As a result of ¹H-NMR and ¹⁹F-NMR analyses, the fluorine-containing polymer (a) having protective group was a fluorine-containing polymer having the structural unit of the formula (NB-2-1), and according to ¹⁹F-NMR analysis, the polymer was one comprising TFE, norbornene derivative (NB-1) having OH group and norbornene derivative (NB-2-1) having protective group in a percent by mole ratio of 50/39/11.

According to GPC analysis, a weight average molecular weight thereof was 3,000.

### PREPARATION EXAMPLE 2

(Synthesis of Norbornene Derivative Having Protective Group Containing Bicyclo Saturated Hydrocarbon Structure W)

Into a 1-liter four-necked flask equipped with a reflux condenser, thermometer, stirrer and dropping funnel were poured 9.6 g of sodium hydride (purity: 60%) and 500 ml of tetrahydrofuran. Then 55.6 g of the above-mentioned norbornene derivative (nb-1) having OH group was added thereto dropwise over one hour while maintaining the inside temperature at 5° to 10° C. After completion of the addition, stirring was continued at room temperature for 1.5 hours.

Then thereto was added dropwise 52.4 g of chloromethyl-2-methyl norbornyl ether over one hour. After completion of the addition, stirring was continued at room temperature for 5 hours.

After completion of the reaction, water was added and an organic substance was extracted with ether, followed by washing of the ether layer with saturated NaHCO₃ solution and drying with anhydrous magnesium sulfate.

After the drying, ether was distilled off for distillation, and 76.3 g of norbornene derivative represented by the formula (nb-2-1): 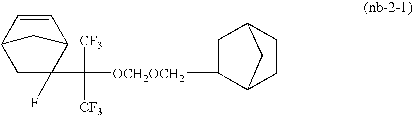
was obtained.

The structure of this compound was determined by GC-Mass, ¹⁹F-NMR and ¹H-NMR analyses.

Measurement by GC-Mass:

QP1000 available from Shimadzu Corporation was used.

### EXAMPLE 3

(Synthesis of Copolymer Comprising TFE, Norbornene Derivative (nb-1) Having OH Group and Norbornene Derivative (nb-2-1) Having Protective Group Containing Bicyclo Saturated Hydrocarbon Structure)

A 500-ml autoclave equipped with a valve, pressure gauge, stirrer and thermometer was subjected to replacement with nitrogen gas several times and evacuation and was charged with 27 g of norbornene derivative (nb-1) having OH group, 15.5 g of norbornene derivative (nb-2-1) having protective group containing bicyclo saturated hydrocarbon structure and prepared in Preparation Example 2 and 250 ml of HCFC-141b.

Then 52 g of tetrafluoroethylene (TFE) gas was introduced through the valve and 17 g of perfluorohexane solution of 10.0% by weight of heptafluorobutanoyl peroxide: (CF₃CF₂CF₂COO)₂ was introduced to initiate reaction with stirring. The inside temperature was maintained at 30° C.

With the advance of the reaction, the inside pressure was decreased, and every time when the inside pressure was decreased from 0.9 MPaG (9.2 kgf/cm²G) before starting of the reaction to 0.85 MPaG (8.7 kgf/cm²G), TFE was additionally introduced to elevate the inside pressure to 0.9 MPaG (9.2 kgf/cm²G). Decreasing of the inside pressure due to the reaction and increasing of the inside pressure by additionally introducing TFE were repeated and the polymerization reaction was continued for 30 hours.

During the polymerization, 8.5 g of perfluorohexane solution of 10.0% by weight of heptafluorobutanoyl peroxide: (CF₃CF₂CF₂COO)₂ was introduced five times, and further 1.35 g (5% of the initially charged amount) of fluorine-containing norbomene derivative (nb-1) having OH group and 0.78 g (5% of the initially charged amount) of norbornene derivative (nb-2-1) having protective group containing bicyclo saturated hydrocarbon structure were additionally introduced ten times.

After completion of the reaction, the un-reacted monomer was released, and the polymerization solution was taken out, followed by concentration and re-precipitation with hexane to separate a copolymer. Until a constant weight was reached, vacuum drying was continued and 22 g of copolymer was obtained.

As a result of ¹H-NMR and ¹⁹F-NMR analyses, the copolymer was one comprising TFE, norbornene derivative (NB-1) having OH group and norbornene derivative (NB-2-1) having protective group in a percent by mole ratio of 50/30/20.

According to GPC analysis, a weight average molecular weight of the copolymer was 2,500.

### EXAMPLE 4

(Introduction of Protective Group Containing Bicyclo Saturated Hydrocarbon Structure W)

Introduction of protective group through polymer reaction and isolation and refining of a polymer were carried out in the same manner as in Example 1 except that 15.2 g of 3-chloromethoxypinane: 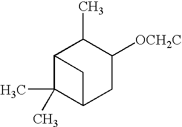
was used instead of chloromethyl-2-methyl norbornyl ether and 600 ml of tetrahydrofuran (THF) was used instead of N,N-dimethylformamide (DMF). As a result, 42.0 g of fluorine-containing polymer (a) having protective group was obtained.

As a result of ¹H-NMR and ¹⁹F-NMR analyses, the fluorine-containing polymer (a) having protective group was a fluorine-containing polymer having a structural unit which was derived from the norbornene derivative having protective group and represented by the formula (NB-2-2):

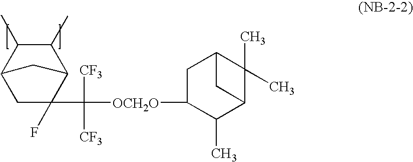

According to ¹⁹F-NMR analysis, the polymer was one comprising TFE, norbornene derivative (NB-1) having OH group and norbornene derivative (NB-2-2) having protective group in a percent by mole ratio of 50/37/13.

According to GPC analysis, a weight average molecular weight thereof was 3,700.

### EXAMPLE 5

(Introduction of Protective Group Containing Bicyclo Saturated Hydrocarbon Structure)

The same procedures as in Example 4 were carried out except that 9.6 g of 3-chloromethoxypinane was used, and 43.0 g of fluorine-containing polymer (a) having protective group was obtained.

As a result of ¹H-NMR and ¹⁹F-NMR analyses, the fluorine-containing polymer (a) having protective group was a fluorine-containing polymer having the structural unit of the formula (NB-2-2), and according to ¹⁹F-NMR analysis, the polymer was one comprising TFE, norbornene derivative (NB-1) having OH group and norbornene derivative (NB-2-2) having protective group in a percent by mole ratio of 50/42/8.

According to GPC analysis, a weight average molecular weight thereof was 3,900.

### PREPARATION EXAMPLE 3

(Synthesis of Norbornene Derivative Having Protective Group Containing Bicyclo Saturated Hydrocarbon Structure)

Reaction and isolation procedures were carried out in the same manner as in Preparation Example 2 except that 40.1 g of 3-chloromethoxypinane was used instead of chloromethyl-2-methyl norbornyl ether, and as a result, 66.3 g of norbornene derivative of the formula (nb-2-2): 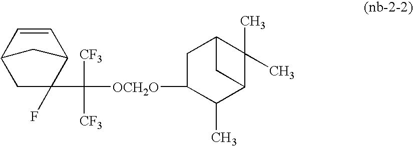
was obtained.

The structure of this compound was determined by GC-Mass, ¹⁹F-NMR and ¹H-NMR analyses.

### EXAMPLE 6

(Synthesis of Copolymer Comprising TFE, Norbornene Derivative (nb-1) Having OH Group and Norbornene Derivative (nb-2-2) Having Protective Group Containing Bicyclo Saturated Hydrocarbon Structure)

Polymerization reaction and isolation and refining of a polymer were carried out in the same manner as in Example 3 except that 21.8 g of norbornene derivative (nb-1) having OH group and 29.5 g of norbornene derivative (nb-2-2) having protective group containing bicyclo saturated hydrocarbon structure and prepared in Preparation Example 3 were used, and 1.09 g of (nb-1) and 1.48 g of (nb-2-2) were additionally introduced ten times. As a result, 21.0 g of fluorine-containing polymer (a) having protective group was obtained.

As a result of ¹H-NMR and ¹⁹F-NMR analyses, the fluorine-containing polymer (a) having protective group was a fluorine-containing polymer having the structural unit of the formula (NB-2-2), and according to ¹⁹F-NMR analysis, the polymer was one comprising TFE, norbornene derivative (NB-1) having OH group and norbornene derivative (NB-2-2) having protective group in a percent by mole ratio of 50/30/20.

According to GPC analysis, a weight average molecular weight thereof was 2,900.

### PREPARATION EXAMPLE 4

(Synthesis of Norbornene Derivative Having Protective Group Containing Bicyclo Saturated Hydrocarbon Structure)

Reaction and isolation procedures were carried out in the same manner as in Preparation Example 2 except that 40.1 g of chloromethyl-2-decahydronaphthyl ether was used instead of chloromethyl-2-methyl norbornyl ether, and as a result, 67.5 g of norbornene derivative of the formula (nb-2-3): 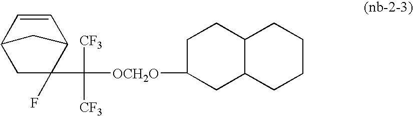
was obtained.

The structure of this compound was determined by GC-Mass, ¹⁹F-NMR and ¹H-NMR analyses.

### EXAMPLE 7

(Synthesis of Copolymer Comprising TFE, Norbornene Derivative (nb-1) Having OH Group and Norbornene Derivative (nb-2-3) Having Protective Group Containing Bicyclo Saturated Hydrocarbon Structure)

Polymerization reaction and isolation and refining of a polymer were carried out in the same manner as in Example 3 except that 28.2 g of norbornene derivative (nb-1) having OH group and 19.3 g of norbornene derivative (nb-2-3) having protective group containing bicyclo saturated hydrocarbon structure and prepared in Preparation Example 4 were used, and 1.41 g of (nb-1) and 0.97 g of (nb-2-3) were additionally introduced ten times. As a result, 20 g of fluorine-containing polymer (a) having protective group was obtained.

As a result of ¹H-NMR and ¹⁹F-NMR analyses, the fluorine-containing polymer (a) having protective group was a copolymer comprising TFE, norbornene derivative (NB-1) having OH group and norbornene derivative (NB-2-3) having protective group in a percent by mole ratio of 50/37/13.

According to GPC analysis, a weight average molecular weight thereof was 2,600.

### COMPARATIVE PREPARATION EXAMPLE 1

(Synthesis of Norbornene Derivative Having Protective Group Containing Monocyclic Hydrocarbon Structure)

Reaction and isolation procedures were carried out in the same manner as in Preparation Example 2 except that 18.5 g of chloromethyl cyclohexyl ether was used instead of chloromethyl-2-methyl norbornyl ether, and as a result, 26.8 g of norbornene derivative of the formula (nb-2-4): 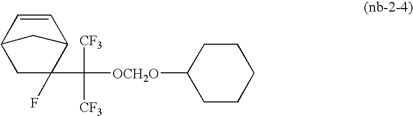
having monocyclic hydrocarbon structure was obtained.

The structure of this compound was determined by GC-Mass, ⁹F-NMR and ¹H-NMR analyses.

### COMPARATIVE EXAMPLE 2

(Synthesis of Copolymer Comprising TFE, Norbornene Derivative (nb-1) Having OH Group and Norbornene Derivative (nb-2-4) Having Protective Group Containing Monocyclic Hydrocarbon Structure)

Polymerization reaction and isolation and refining of a polymer were carried out in the same manner as in Example 3 except that 27.2 g of norbornene derivative (nb-1) having OH group and 17.5 g of norbornene derivative (nb-2-4) having protective group containing monocyclic hydrocarbon structure and prepared in Comparative Preparation Example 1 were used, and 1.36 g of (nb-1) and 0.88 g of (nb-2-4) were additionally introduced ten times. As a result, 22.0 g of fluorine-containing polymer having protective group containing monocyclic hydrocarbon structure was obtained.

As a result of ¹H-NMR and ¹⁹F-NMR analyses, the fluorine-containing polymer having protective group was a copolymer comprising TFE, norbomene derivative (NB-1) having OH group and norbornene derivative (NB-2-4) having protective group containing monocyclic hydrocarbon structure in a percent by mole ratio of 50/36/14.

According to GPC analysis, a weight average molecular weight thereof was 3,200.

### COMPARATIVE PREPARATION EXAMPLE 2

(Synthesis of Norbornene Derivative Having Protective Group Containing Tricyclic Hydrocarbon Structure)

Reaction and isolation procedures were carried out in the same manner as in Preparation Example 2 except that 18.5 g of chloromethyl-2-adamantyl ether was used instead of chloromethyl-2-methyl norbornyl ether, and as a result, 26.8 g of norbornene derivative of the formula (nb-2-5): 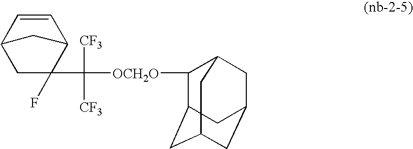
having protective group containing tricyclic hydrocarbon structure was obtained.

The structure of this compound was determined by GC-Mass, ¹⁹F-NMR and ¹H-NMR analyses.

### COMPARATIVE EXAMPLE 3

(Synthesis of Copolymer Comprising TFE, Norbornene Derivative (nb-1) Having OH Group and Norbornene Derivative (nb-2-5) Having Protective Group Containing Tricyclic Hydrocarbon Structure)

Polymerization reaction and isolation and refining of a polymer were carried out in the same manner as in Example 3 except that 27.2 g of norbornene derivative (nb-1) having OH group and 18.5 g of norbornene derivative (nb-2-5) having protective group containing tricyclic hydrocarbon structure and prepared in Comparative Preparation Example 2 were used, and further 1.36 g of (nb-1) and 0.93 g of (nb-2-5) were additionally introduced ten times. As a result, 21 g of fluorine-containing polymer having protective group was obtained.

As a result of ¹H-NMR and ¹⁹F-NMR analyses, the fluorine-containing polymer having protective group was a copolymer comprising TFE, norbornene derivative (NB-1) having OH group and norbornene derivative (NB-2-5) having protective group containing tricyclic hydrocarbon structure in a percent by mole ratio of 50/36/14.

According to GPC analysis, a weight average molecular weight thereof was 2,600.

### EXPERIMENTAL EXAMPLES 1 to 10

(Evaluation of Transparency and Dry Etching Resistance)

(1) Measurement of Transparency (Absorption Coefficient) at 157 nm (Measuring Equipment)

Spectroscopic ellipsometer available from J. A. Woollam, Co., Inc., product name: VUV-VASE

(Production of Fluorine-containing Polymer Coating Film)

The fluorine-containing polymers obtained in Examples 1 to 7 and Comparative Examples 1 to 3 were dissolved in propylene glycol monomethyl ether acetate (PGMEA) to obtain the respective 10% solutions.

Those solutions were coated on a Si substrate using a spin coater and dried at 110° C. to obtain about 90 nm to about 200 nm thick coating films.

(Measurement of Transparency)

Absorbance at 157 nm was measured with the above-mentioned spectroscopic ellipsometer using the Si substrates provided with the fluorine-containing polymer coating film, and an absorption coefficient was calculated from a coating thickness of each coating film. The results are shown in Table 1.

(2) Measurement of Dry Etching Resistance

PGMEA solutions of 10% by weight of fluorine-containing copolymers obtained in Examples 1 to 7 and Comparative Examples 1 to 3 were prepared, and the solutions were coated on a silicon wafer using a spin coater so that a coating thickness became about 200 nm. The coating films were subjected to pre-baking at 110° C. for one minute to produce a coated silicon wafer. A coating thickness of the fluorine-containing copolymer film on the wafer was measured with a spectrometric film thickness meter (LAMBDA ACE available from Dai-Nippon Screen Insatsu Kabushiki Kaisha).

Then the coated silicon wafer was subjected to etching at an etching time of 60 seconds under the following etching conditions.

(Etching Conditions)

Equipment: Unity dry etching machine (available from Tokyo Electron Kabushiki Kaisha)
Pressure: 80 mTorr
Etching gas: CF₄/O₂
Electric power: 500 W
Temperature: Upper temperature of 60° C., Wall temperature of 40° C.,

A coating thickness of the fluorine-containing copolymer film on the wafer after the etching was measured with a spectrometric film thickness meter (LAMBDA ACE available from Dai-Nippon Screen Insatsu Kabushiki Kaisha), and an etching rate was calculated from the film thickness before the etching.

An etching rate of KrF resist (XP-2332C available from Shipley Co., Inc.) which was usually used in resist industries for the use for relative evaluation of an etching rate was measured in the same manner under the same etching conditions as above.

The etching rates (RIE rate) of the fluorine-containing copolymers of Examples 1 to 7 and Comparative Examples 1 to 3 were calculated assuming that the etching rate of KrF resist was 1. The results are shown in Table 1.

TABLE 1

| | | (1) Transparency | |
|---|---|---|---|
| | | at 157 nm | (2) Dry etching |
| Experimental | Fluorine-containing | Absorption | resistance |
| Example | polymer (a) | coefficient (μm⁻¹) | RIE rate |
| 1 | Ex. 1 | 0.60 | 1.60 |
| 2 | Ex. 2 | 0.48 | 1.68 |
| 3 | Ex. 3 | 0.71 | 1.54 |
| 4 | Ex. 4 | 1.15 | 1.44 |
| 5 | Ex. 5 | 0.96 | 1.55 |
| 6 | Ex. 6 | 1.16 | 1.48 |
| 7 | Ex. 7 | 0.95 | 1.61 |
| 8 | Com. Ex. 1 | 0.37 | 1.80 |
| 9 | Com. Ex. 2 | 0.45 | 1.73 |
| 10 | Com. Ex. 3 | 1.27 | 1.52 |

| | | |
|---|---|---|
| KrF resist | 6.6 | 1 |

### EXPERIMENTAL EXAMPLE 11

(Evaluation of F₂ exposing)

To 100 parts by weight of fluorine-containing copolymer obtained in Example 4 was added 2 parts by weight of triphenylsulfonium-trifluoromethylsulfonate as a photoacid generator, and the mixture was dissolved in 2-heptanone (MAK) to prepare a resist composition having a polymer concentration of 10%. The resist composition was coated using a spin coater on a silicon wafer, to which a 85 nm thick antireflection film (DUV-30J available from Brewer Science Co., Ltd.) had been applied, and was dried at 110° C. for 60 seconds to form a 150 nm thick resist film.

This resist film was subjected to frame exposure on a 1 cm×1 cm (1 cm²) square spot by using F₂ laser beam (wavelength 157 nm). After the exposing, the resist film was subjected to heating on a heated plate at 110° C. for 90 seconds and then developing treatment (60 seconds) with an aqueous solution of tetramethylammonium hydroxide (TMAH) having a concentration of 2.38% by weight.

When the above-mentioned frame exposure, heating and developing were carried out in the same manner as above by changing exposure energy of F₂ laser beam from 0.1 mJ/cm² to 100 mJ/cm², the spot of 1 cm2 was completely dissolved at the exposure of not less than 8.2 mJ/cm², from which it was found that the fluorine-containing copolymer prepared in Example 4 had sensitivity which could make the copolymer function as a positive type resist.

Then evaluation of patterning was carried out using a 150 nm thick resist film obtained in the same manner as above.

The patterning was evaluated by using a reduction projection exposure system (157 nm micro stepper available from Exitech Limited.: Levenson mask, NA/σ=0.90/0.30 Conv.) using F₂ laser as light source. As a result, a 60 nm fine pattern of 1:1 L/S could be produced at an exposure energy of 97 mJ/cm². From this, it was found that the resist composition prepared from the fluorine-containing polymer obtained in Example 4 had excellent resolution which could provide a fine pattern.

According to the method of forming fine pattern of the present invention, a highly practicable fine resist pattern which can be used for producing a highly integrated circuit such as a semiconductor device can be formed by using a specific fluorine-containing polymer having OH group which has specific protective groups and are capable of acting for a positive resist.

1. A method of forming a fine pattern which comprises:
(I) a step for preparing a resist composition comprising:
(a) a fluorine-containing polymer having protective group,
(b) a photoacid generator and
(c) a solvent;
(II) a step for forming a resist film comprising the above-mentioned resist composition on a substrate or on a given layer on the substrate;
(III) a step for exposing by selectively irradiating given areas of the resist film with energy ray, and
(IV) a step for subjecting the exposed resist film to developing treatment and selectively removing the exposed portions of the resist film to form a fine pattern,
in which the fluorine-containing polymer (a) having protective group is a fluorine-containing polymer comprising a structural unit (M2-1A) derived from a norbornene derivative (m2-1a) having OH group which has a moiety represented by the formula (1): 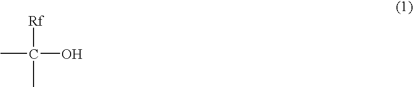
wherein Rf is a fluorine-containing alkyl group having 1 to 5 carbon atoms, and
a structural unit (M2-1B) derived from a norbornene derivative (m2-1b) having protective group which has a moiety represented by the formula (2): 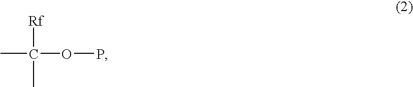
wherein Rf is as defined in said formula (1); —O—P is a protective group which is converted to OH group due to reaction with an acid, in which —P is represented by: 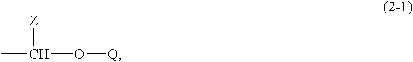
wherein Z is hydrogen atom or CH₃; Q is a saturated hydrocarbon group having 4 to 15 carbon atoms which has a bicyclo saturated hydrocarbon structure W and the number of carbon atoms forming the ring structure W of said bicyclo saturated hydrocarbon is from 4 to 12.

2. The method of forming a fine pattern of claim 1, wherein in the formula (2-1) representing —P in the protective group —O—P, Z is hydrogen atom.

3. The method of forming a fine pattern of claim 1, wherein in the protective group containing —P of the formula (2-1) in the fluorine-containing polymer (a) having protective group, the hydrocarbon group Q having the bicyclo saturated hydrocarbon structure W is a cyclic hydrocarbon group represented by the formula (2-2): 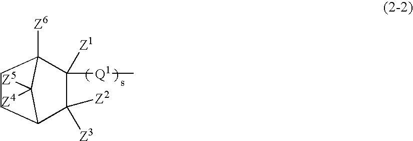
wherein Q¹ is an alkylene group having 1 to 5 carbon atoms, in which a part or the whole of hydrogen atoms may be substituted with fluorine atoms; Z¹ is at least one selected from hydrogen atom, fluorine atom or an alkyl group having 1 to 5 carbon atoms, in which a part or the whole of hydrogen atoms may be substituted with fluorine atoms; Z² and Z³ are the same or different and each is at least one selected from hydrogen atom, fluorine atom, CH₃ and CF₃; Z⁴, Z⁵ and Z⁶ are the same or different and each is hydrogen atom or CH₃; s is 0 or 1.

4. The method of forming a fine pattern of claim 3, wherein in the formula (2-2) representing the hydrocarbon group Q having the bicyclo saturated hydrocarbon structure W, Z¹ is hydrogen atom, s is 1 and Q¹ is —CH₂—.

5. The method of forming a fine pattern of claim 3, wherein in the formula (2-2) representing the hydrocarbon group Q having the bicyclo saturated hydrocarbon structure W, all of Z², Z³, Z⁴, Z⁵ and Z⁶ are hydrogen atoms.

6. The method of forming a fine pattern of claim 1, wherein in the protective group containing —P of the formula (2-1) in the fluorine-containing polymer (a) having protective group, the hydrocarbon group Q having the bicyclo saturated hydrocarbon structure W is at least one cyclic hydrocarbon group selected from the group represented by the formulae (2-3-1), (2-3-2), (2-3-3) and (2-3-4): 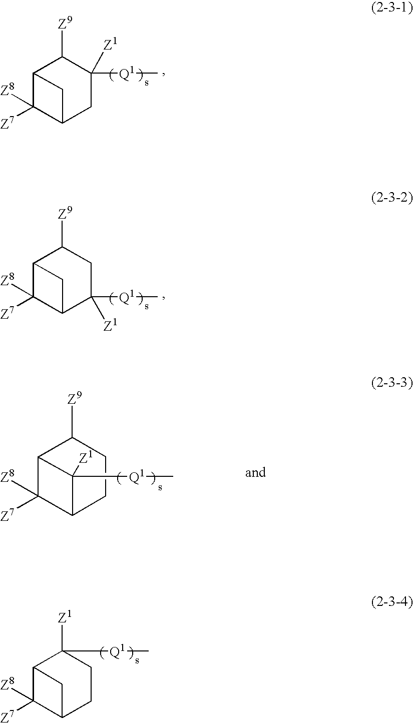
wherein Q¹, Z¹ and s are as defined in said formula (2-2); Z⁷, Z⁸ and Z⁹ are the same or different and each is hydrogen atom or CH₃.

7. The method of forming a fine pattern of claim 6, wherein the hydrocarbon group Q having the bicyclo saturated hydrocarbon structure W is the cyclic hydrocarbon group represented by said formula (2-3-1).

8. The method of forming a fine pattern of claim 6, wherein in the formulae (2-3-1), (2-3-2), (2-3-3) and (2-3-4) representing the hydrocarbon group Q having the bicyclo saturated hydrocarbon structure W, all of Z⁷, Z⁸ and Z⁹ are CH₃.

9. The method of forming a fine pattern of claim 1, wherein the fluorine-containing polymer (a) having protective group is a fluorine-containing polymer represented by the formula (M-1):
-(M1)-(M2-1A)-(M2-1B)-(N)- (M-1)
wherein the structural unit M1 is a structural unit derived from a fluorine-containing ethylenic monomer (m1) having 2 or 3 carbon atoms and at least one fluorine atom;
the structural unit M2-1A is a structural unit derived from the norbornene derivative (m2-1a) having OH group which has the moiety represented by said formula (1);
the structural unit M2-1B is a structural unit derived from the norbornene derivative (m2-1b) having protective group which has the moiety represented by said formula (2);
the structural unit N is a repeat unit derived from a monomer (n) copolymerizable with the monomers (m1), (m2-1a) and (m2-1b);
the structural units M1, M2-1A, M2-1B and N are contained in amounts of from 24 to 70% by mole, from 1 to 69% by mole, from 1 to 69% by mole and from 0 to 20% by mole, respectively, and when (M1)+(M2-1A) +(M2-1B) is assumed to be 100% by mole, a percent by mole ratio of (M1)/((M2-1A)+(M2-3B)) is 30/70 to 70/30.

10. The method of forming a fine pattern of claim 1, wherein the structural unit (M2-1A) derived from a norbornene derivative having OH group is a structural unit derived from a norbornene derivative represented by the formula (m2-2a): 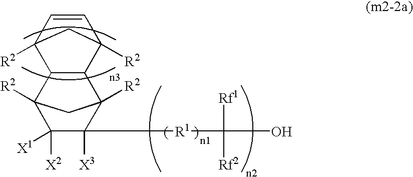
wherein X³ is selected from hydrogen atom, fluorine atom or CF₃, and when n2 is 0, X³ is CF₃; X¹ and X² are the same or different and each is hydrogen atom or fluorine atom; R¹ is at least one divalent hydrocarbon group selected from divalent hydrocarbon groups which have 1 to 5 carbon atoms and may have ether bond and divalent hydrocarbon groups which have 1 to 5 carbon atoms and may have ether bond, in which a part or the whole of hydrogen atoms are substituted with fluorine atoms; Rf¹ and Rf² are the same or different and each is a fluorine-containing alkyl group having 1 to 5 carbon atoms; R² are the same or different and each is hydrogen atom or an alkyl group having 1 to 10 carbon atoms; n1and n2 are the same or different and each is 0 or 1; n3 is 0 or an integer of from 1 to 5.

11. The method of forming a fine pattern of claim 1, wherein the structural unit (M2-1B) derived from a norbornene derivative having protective group is a structural unit derived from a norbornene derivative represented by the formula (m2-2b): 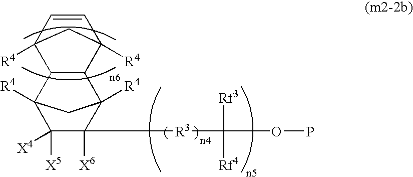
wherein —O—P is a protective group which can be converted to OH group due to dissociation reaction with an acid, and —P is represented by said formula (2-1); X⁶ is selected from hydrogen atom, fluorine atom or CF₃, and when n5 is 0, X⁶ is CF₃; X⁴ and X⁵ are the same or different and each is hydrogen atom or fluorine atom; R³ is at least one divalent hydrocarbon group selected from divalent hydrocarbon groups which have 1 to 5 carbon atoms and may have ether bond and divalent hydrocarbon groups which have 1 to 5 carbon atoms and may have ether bond, in which a part or the whole of hydrogen atoms are substituted with fluorine atoms; Rf³ and Rf⁴ are the same or different and each is a fluorine-containing alkyl group having 1 to 5 carbon atoms; R⁴ are the same or different and each is hydrogen atom or an alkyl group having 1 to 10 carbon atoms; n4 and n5 are the same or different and each is 0 or 1; n6 is 0 or an integer of from 1 to 5.

12. The method of forming a fine pattern of claim 9, wherein the structural unit (M1) derived from said fluorine-containing ethylenic monomer (m1) is a structural unit derived from tetrafluoroethylene or chlorotrifluoroethylene.

13. The method of forming a fine pattern of claim 1, wherein F₂ excimer laser beam is used as energy ray.

14. A resist composition comprising:
(a) a fluorine-containing polymer having protective group,
(b) a photoacid generator and
(c) a solvent;
in which said fluorine-containing polymer (a) having protective group is a fluorine-containing polymer comprising a structural unit (M2-1A) derived from a norbornene derivative (m2-1a) having OH group which has a moiety represented by the formula (1): 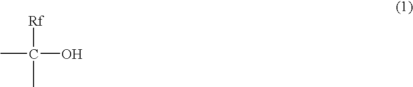
wherein Rf is a fluorine-containing alkyl group having 1 to 5 carbon atoms, and
a structural unit (M2-1B) derived from a norbornene derivative (m2-1b) having protective group which has a moiety represented by the formula (2): 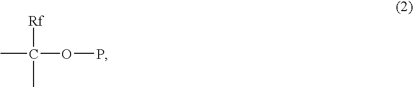
wherein Rf is as defined in said formula (1); —O—P is a protective group which is converted to OH group due to reaction with an acid, in which —P is represented by the formula (2-1): 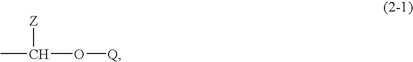
wherein Z is hydrogen atom or CH₃; Q is a saturated hydrocarbon group having 4 to 15 carbon atoms which has a bicyclo saturated hydrocarbon structure W and the number of carbon atoms forming the ring structure W of said bicyclo saturated hydrocarbon is from 4 to 12.

15. The resist composition of claim 14, wherein in the formula (2-1) representing —P in the protective group —O—P, Z is hydrogen atom.

16. The resist composition of claim 14, wherein in the protective group containing —P of said formula (2-1) in the fluorine-containing polymer (a) having protective group, the hydrocarbon group Q having the bicyclo saturated hydrocarbon structure W is a cyclic hydrocarbon group represented by the formula (2-2): 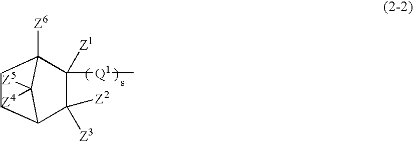
wherein Q¹ is an alkylene group having 1 to 5 carbon atoms, in which a part or the whole of hydrogen atoms may be substituted with fluorine atoms; Z¹ is at least one selected from hydrogen atom, fluorine atom or an alkyl group having 1 to 5 carbon atoms, in which a part or the whole of hydrogen atoms may be substituted with fluorine atoms; Z² and Z³ are the same or different and each is at least one selected from hydrogen atom, fluorine atom, CH₃ and CF₃; Z⁴, Z⁵ and Z⁶ are the same or different and each is hydrogen atom or CH₃; s is 0 or 1.

17. The resist composition of claim 16, wherein in the formula (2-2) representing the hydrocarbon group Q having the bicyclo saturated hydrocarbon structure W, Z¹ is hydrogen atom, s is 1 and Q¹ is —CH₂—.

18. The resist composition of claim 16, wherein in the formula (2-2) representing the hydrocarbon group Q having the bicyclo saturated hydrocarbon structure W, all of Z², Z³, Z⁴, Z⁵ and Z⁶ are hydrogen atoms.

19. The resist composition of claim 14, wherein in the protective group containing —P of said formula (2-1) in the fluorine-containing polymer (a) having protective group, the hydrocarbon group Q having the bicyclo saturated hydrocarbon structure W is at least one cyclic hydrocarbon group selected from the group represented by the formulae (2-3-1), (2-3-2), (2-3-3) and (2-3-4): 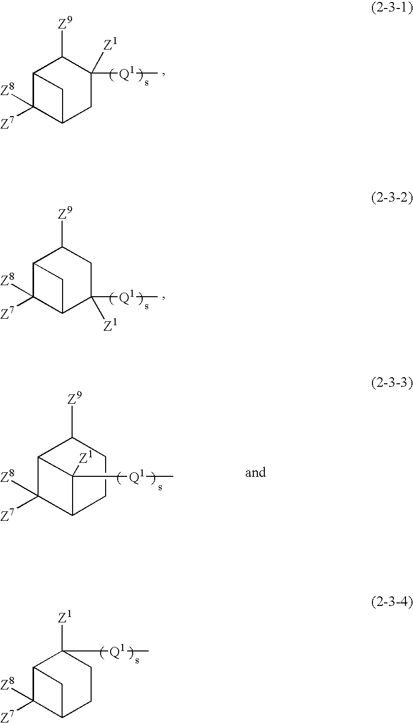
wherein Q¹, Z¹ and s are as defined in said formula (2-2); Z⁷, Z⁸ and Z⁹ are the same or different and each is hydrogen atom or CH₃.

20. The resist composition of claim 19, wherein the hydrocarbon group Q having the bicyclo saturated hydrocarbon structure W is the cyclic hydrocarbon group represented by said formula (2-3-1).

21. The resist composition of claim 19, wherein in the formulae (2-3-1), (2-3-2), (2-3-3) and (2-3-4) representing the hydrocarbon group Q having the bicyclo saturated hydrocarbon structure W, all of Z⁷, Z⁸ and Z⁹ are CH₃.

22. The resist composition of claim 14, wherein the fluorine-containing polymer (a) having protective group is a fluorine-containing polymer represented by the formula (M-1):
-(M1)-(M2-1A)-(M2-1B)-(N)- (M-1)
wherein the structural unit M1 is a structural unit derived from a fluorine-containing ethylenic monomer (m1) having 2 or 3 carbon atoms and at least one fluorine atom;
the structural unit M2-1A is a structural unit derived from the norbornene derivative (m2-la) having OH group which has the moiety represented by said formula (1);
the structural unit M2-1B is a structural unit derived from the norbornene derivative (m2-1b) having protective group which has the moiety represented by said formula (2);
the structural unit N is a repeat unit derived from a monomer (n) copolymerizable with the monomers (m1), (m2-1a) and (m2-1b); the structural units M1, M2-1A, M2-1B and N are contained in amounts of from 24 to 70% by mole, from 1 to 69% by mole, from 1 to 69% by mole and from 0 to 20% by mole, respectively, and when (M1)+(M2-1A) +(M2-1B) is assumed to be 100% by mole, a percent by mole ratio of (M1)/((M2-1A)+(M2-3B)) is 30/70 to 70/30.

23. The resist composition of claim 14, wherein the structural unit M2-1A derived from the norbornene derivative having OH group is a structural unit derived from a norbornene derivative represented by the formula (m2-2a): 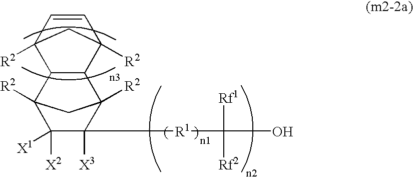
wherein X³ is selected from hydrogen atom, fluorine atom or CF₃, and when n2 is 0, X³ is CF₃; X¹ and X² are the same or different and each is hydrogen atom or fluorine atom; R¹ is at least one divalent hydrocarbon group selected from divalent hydrocarbon groups which have 1 to 5 carbon atoms and may have ether bond and divalent hydrocarbon groups which have 1 to 5 carbon atoms and may have ether bond, in which a part or the whole of hydrogen atoms are substituted with fluorine atoms; Rf¹ and Rf² are the same or different and each is a fluorine-containing alkyl group having 1 to 5 carbon atoms; R² are the same or different and each is hydrogen atom or an alkyl group having 1 to 10 carbon atoms; n1 and n2 are the same or different and each is 0 or 1; n3 is 0 or an integer of from 1 to 5.

24. The resist composition of claim 14, wherein the structural unit M2-1B derived from the norbornene derivative having protective group is a structural unit derived from a norbornene derivative represented by the formula (m2-2b): 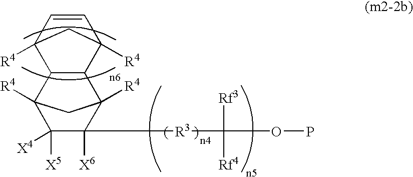
wherein —O—P is a protective group which can be converted to OH group due to dissociation reaction with an acid, and —P is represented by said formula (2-1); X⁶ is selected from hydrogen atom, fluorine atom or CF₃,
and when n5 is 0, X⁶ is CF₃; X⁴ and X⁵ are the same or different and each is hydrogen atom or fluorine atom; R³ is at least one divalent hydrocarbon group selected from divalent hydrocarbon groups which have 1 to 5 carbon atoms and may have ether bond and divalent hydrocarbon groups which have 1 to 5 carbon atoms and may have ether bond, in which a part or the whole of hydrogen atoms are substituted with fluorine atoms; Rf³ and Rf⁴ are the same or different and each is a fluorine-containing alkyl group having 1 to 5 carbon atoms; R⁴ are the same or different and each is hydrogen atom or an alkyl group having 1 to 10 carbon atoms; n4 and n5 are the same or different and each is 0 or 1; n6 is 0 or an integer of from 1 to 5.

25. The resist composition of claim 22, wherein the structural unit (M1) derived from said fluorine-containing ethylenic monomer (m1) is a structural unit derived from tetrafluoroethylene or chlorotrifluoroethylene.
